(19) United States
(12) Patent Application Publication
(10) Pub. No.: US 2023/0174870 A1
(43) Pub. Date: Jun. 8, 2023

(54) Configurable Universal Wellbore Reactor System

(71) Applicant: PYROPHASE, INC., Chicago, IL (US)

(72) Inventors: Geoffrey Ward Presley, Spokane, WA (US); Thomas Christian Valenti, Spokane, WA (US); Jesse Ronald Mohrbacher, Anchorage, AK (US)

(21) Appl. No.: 17/926,197

(22) PCT Filed: May 21, 2021
(86) PCT No.: PCT/US2021/033736

§ 371 Date: Nov. 18, 2022

Related U.S. Application Data
(60) Provisional application No. 63/027,963, filed on May 21, 2020.

(51) Int. Cl. C10G 1/10; F16L 53/34; E21B 17/00; E21B 36/04

(52) U.S. Cl. CPC C10G 1/10; E21B 17/003; E21B 36/04; F16L 53/34; C10G 2300/1003; C10G 2300/4062

(57) ABSTRACT

A configurable universal wellbore reactor system designed for localized heat, pressure, and reaction control, to facilitate desired reactor conditions to transform feedstocks to recoverable products via diluent- based processes and/or reactions. The present system provides for a universal wellbore reactor for the diluent transformation of a diverse range of feedstocks, such as hydrocarbon waste, municipal waste, industrial waste, and/or mineral rich resources to recoverable product(s). Heat and temperature within the wellbore reactor are controlled by configuring various reactor components to govern the direction and magnitude of internal and external heat transfer within. Together with skin frequency heat transfer of ferromagnetic reactor piping at predetermined locations, the required temperature(s) and pressure(s) for the desired targeted reactions and/ or transformation reactions are achieved. The universal wellbore reactor system comprises one or more wellbore reactors with configurable features to improve reactor dynamics, reaction mechanisms and/or quality of the recoverable product, to facilitate a wide range of transformation reactions ranging from near ambient, to beyond the critical point of the diluent.

### FIELD OF INVENTION

This system relates to an apparatus for, and method to transform feedstocks to recoverable products. More specifically, to an apparatus that utilizes elevated temperatures and/or pressures to transform feedstocks into recoverable products via diluent and/or biotic based processes.

### BACKGROUND OF THE INVENTION

There is a global need to develop the technology and infrastructure to produce recoverable products, bioenergy and/or advanced materials. Carbon-neutral, renewable biofuels should be economic and compatible with existing combustion systems/fueling infrastructures. A sustainable, stable, and abundant supply of advanced materials are essential to supporting emerging high density, clean energy technologies for defense and/or commercial applications such as, advanced batteries, motors, alloys, semiconductors, and countless future technology applications. Current approaches are non-sustainable and non-economic due to the energy, environmental degradation and direct activity inputs required to create, harvest, and/or extract feedstocks for these critical applications.

Waste, low quality, or other feedstocks with limited demand/economic value are favorable since they are abundantly available at low cost from stable supplies, while limiting/eliminating direct energy inputs and/or production activities. Oftentimes, these feedstocks have challenges including but not limited to inherently complex/rigid molecular structures and/or deficient chemical compositions making them prone to producing substandard products. For example, hydrocarbon waste has a low Hydrogen:Carbon ratio and a high oxygen, moisture, and ash composition, which reduce the quality and desirability of the recoverable products such as biofuels produced from them. Many different industrial and/or municipal wastes such as fly ash, mine tailings and/or end of life products comprise considerable quantities of valuable metallic compounds that can be used as the building blocks of advanced materials. However, they are often encapsulated in waste by hard/rigid molecular structures, such as silica/glass which need to be broken down first before these valuable components can be extracted.

The use of diluent at elevated temperatures and pressures has been established in the art to break down complex/rigid molecular structures, to depolymerize large hydrocarbon chains and/or free advanced materials from silicas, zircons, glasses, and/or other encapsulating matrices, thus creating recoverable products. Due to the compositional complexity, variability, and diversity of potential feedstocks and recoverable products, there is no singular, well defined set of reaction pathways or reactor dynamics representative of an optimum and/or desired transformation. Furthermore, any combination of reaction mechanisms may exist to varying degrees, that comprise both desirable and undesirable pathways such as: de-polymerization, solvent dissociation, solvolysis, hydrolysis, dehydration, decarboxylation, steam reforming, CO₂ reforming, water gas shift, steam cracking, thermal cracking, Boudouard, hydrogenation, methanation, polymerization, Fischer-Tropsch, aldol condensation, retro-aldol, esterification, methanol synthesis, isomerization, ring opening, saturation, mesophilic, thermophilic, aerobic and anaerobic digestion, and/or other mechanisms that reduce the size, complexity and/or structural rigidity of the waste components, and/or form other reform intermediates, radicals and/or any precursors/intermediates thereof.

Addressing these challenges with techniques known in the art requires complex processes that come with many technological challenges and prohibitive costs associated with the design, scaling and/or safe containment of reactor systems. Shell (EP 0,204,354), Steeper (USP 9,822,310) and Licella (USP 8,579,996) teach a series of complex reactors operating at a precise set of reaction conditions utilizing hydrothermal and/or supercritical water to convert biomass such as wood to bio-oil. Widespread adoption of their techniques is challenged due to: particle size reduction and homogenization; limited throughput, high pressure pumping of highly viscous feeds; achieving efficient rapid heat rates via traditional techniques; maintaining reactor homogenization; high energy loss to the environment; and/or other process constraints/limitations that restrict the ability to effectively facilitate desirable reactor dynamics and/or reaction mechanisms.

US10920152 (Snow R. et al.) teaches a wellbore reactor with 3 distinct reactor zones, using supercritical water at a range of 400-450° C. and 250-350 bar to upgrade a specific set of heavy hydro-carbonaceous feedstock into high quality, non-renewable/non-sustainable crude oil, preferably from bituminous sources, resulting in an upgraded petroleum crude oil with a lower molecular weight fraction. Process temperature is achieved by heat exchange between the downflowing feed and up flowing product, followed by radio frequency heating of the reactor piping.

The configurable universal wellbore reactor system is an apparatus and method designed to safely contain the high pressures, diluents and temperatures that may be present during the transformation process. By emplacing those reactions in a wellbore that is configurable to a multitude of process steps and conditions, as described herein, the wellbore system serves as the replacement to a multitude of surface facilities, which otherwise would be needed to be custom constructed from materials suitable to safely contain them at the volumes needed for commercial operation.

### BRIEF DESCRIPTION OF THE FIGURES

FIG. 1: An example wellbore reactor with heat exchange annulus comprising outer channel input and discontinuous heating for the upflowing output.

FIG. 2: A top-down cutaway view of wellbore reactor with heat exchange annulus comprising optional features including two fishbone lateral configurations (92-95) and configurations of reactor tubing.

FIG. 3: An example wellbore reactor with direct heat exchange with a pass-through circuit return in the outer channel connects the inner piping comprising continuous ferromagnetic energized components and outer piping comprising continuous nonmagnetic energized components.

FIG. 4: An example wellbore reactor with direct heat exchange with a pass-through circuit return in the inner channel that connects the inner piping and central conductor comprising continuous ferromagnetic energized components.

FIG. 5: a detailed view of the heat exchange annulus with optional features such as reaction baskets (631, 633), activator tubing (681, 684, 685) and siphon pipe (601).

FIG. 6: a detailed view of the heat exchange annulus with optional features such as reaction baskets (634, 632), heat transfer tubing (517) and flow (676) pressure control tube (662) and siphon pipe (602).

FIG. 7: a detailed view of the heat exchange annulus showing heat transfer control mechanisms including pipe structure modifications (644, 691, 695) to increase turbulence, and heat transfer media to increase or retard heat exchange. The skin frequency heat transfer of the energizable components directly supplies heat to inner (771)

FIG. 8: a detailed portion of a wellbore reactor with direct heat exchange with protection zone heat transfer tubing (672), to enhance cooling (763, 765) of the output, and piping modifications (698) clad with reaction agents, pass-through circuit return (467) between the inner pipe and central conductor (450) comprising electro insulation (477) and a siphon pipe (606) within it to recover precipitate.

FIG. 9: a detailed portion of a wellbore reactor with direct heat exchange and a central conductor showing various passthrough centralizer structure configurations (524, 523, 522), and fluidic heat transfer media provides supplemental heat (767) to the downflowing outer channel.

FIG. 10: a detailed portion of a wellbore reactor with direct heat exchange, wherein the ferromagnetic energized components are on the inner and outer piping, wherein piping modifications increase the magnitude of skin frequency heat transfer, and auxiliary heat transfer tubing (764) in the protection annulus (674) cools the upflowing outer channel.

FIG. 11: a detailed portion of a wellbore reactor with direct heat exchange, wherein electro-insulators on the inner (479) and outer pipe (480) and centralizers (531, 532, 533) ensure the electrical isolation.

FIG. 12: Wellbore reactors with various lateral configurations. 12A: A wellbore reactor with a horizontal lateral at maximum depth. 12B: A wellbore reactor with a diagonal lateral at maximum depth. 12C: A slanted wellbore reactor with a horizontal lateral at maximum depth. 12D: wellbore reactor with an intermediate lateral

FIG. 13: Wellbore reactors with fishbone laterals. 13A: dropout fishbone laterals (94) at different depths, partial diverters direct the flow to the lateral and precipitate is captured and removed by siphon pipes. 13B: full fishbone laterals (92) with full diverters (93).

FIG. 14A: wellbore reactor tubing configured for tortuous flow by downhole pressure devices that extrude inwardly (551) and outwardly (552) or orifice (553)

FIG. 14B: a wellbore reactor with a larger outer channel

FIG. 15 A-D: a wellbore reactor configurations tapers (84) to vary the diameter of the reactor piping to change the pressure, velocity and/or heat transfer dynamics.

FIG. 16: shows some of the operations that process and deliver feedstocks to the wellbore reactor and recover outputs from the reactor, leading to recoverable products.

FIG. 17: shows some of the operations that preheat the feed mixture by utilizing heat transfer fluid (676) from the reactor, multiple process coolants (34), and the combustion of recoverable products to provide direct heat (36) or to generate electrical power (37) for the frequency generator.

FIG. 18: two wellbore reactors, with the output of the first configured to feed the input of the second

FIG. 19A: a sample wellbore reactor configured for batch or semi-batch operations

FIG. 19B: shows the configuration of pressure control tubing to increase (666) or decrease (665) pressure

FIG. 20: the simulation results of Example 1

FIG. 21: the simulation results of Example 2

FIG. 22: the simulation results of Example 3

FIG. 23: the simulation results of Example 4

FIG. 24: the simulation results of Example 5

### SUMMARY OF INVENTION

This system teaches a reactor that is highly configurable for the transformation of a wide range/category of feedstocks such as: hydrocarbon wastes, municipal wastes, industrial wastes, and/or mineral rich resources. The universal wellbore reactor system herein offers process controls, design, and operational flexibility to control critical parameters easily, and independently, such as: surface pretreatment of feedstock, the heat transfer dynamics, and temperatures thereof; pressure control, subsurface heat transfer dynamics and temperatures, reaction residence time(s), reaction agents and activators. This addresses the complex combination of desirable versus undesirable reaction mechanisms that may be present.

The universal wellbore reactor system comprises one or more wellbores configured as reactors that utilize internal heat transfer, external heat transfer and skin frequency heat transfer of energizable components to facilitate transformation reactions ranging from near-ambient conditions to beyond the supercritical phase of the diluent(s), to produce recoverable products. One or more wellbore reactors operate in recirculating batch, semi-batch, and/or continuous operations capable of facilitating Near Ambient Transformation (NAT), Hyperthermal Transformation (HTT) and Super Critical Diluent Transformation (SCDT) to produce recoverable products such as: crude oil substitutes, substitutes for final fuels, components of petroleum products, combustible hydrocarbon gases, hydrogen gas, liquid and/or vapor fraction of organic compounds, Rare Earth Elements (REE), critical materials, precious metals, advanced carbon (for example, graphene) and any other such products that can have a material economic benefit.

The design of the wellbore reactor achieves its volume from a relatively small diameter vessel, emplaced into the subsurface formation which can contain highly elevated pressures, up to 6000 bar, and/or highly elevated temperatures, up to 760° C. This flexible design can net large scale reactor volumes yet be readily and safely deployed and operated for a wide range of feedstocks and throughputs. Additional throughput (scaling) may be achieved with the installation of more wellbores, which may be similarly configured or substantially different depending on the feedstock and targeted transformation reactions.

Advantageously, the hydrostatic pressure generated by the depth, length and/or other components within the wellbore contributes towards establishing the desired pressure profile, wherein the wellbore reactor’s injection pump (28) need only provide a portion of the pressure.

The universal wellbore reactor system enhances energy efficiency. First, the surrounding subsurface formation has an increasing geothermal temperature with depth, which can provide thermal energy to the system in some embodiments. Second the subsurface formation is a natural insulator, reducing heat loss to the environment and eliminating the complexities of adapting to seasonal temperature variations. Third, the protection annulus can have supplemental insulation added to further reduce heat losses.

Furthermore, dynamics unique to hundreds or thousands of ft of flow within a wellbore reactor offer many unique advantages thereof. The thermo-fluidic dynamics of the downflowing reactor input and the upflowing reactor output within the inner (260) and outer (270) channels, can enable mixing, intermediate reactions, and in addition to the localized configuration of the boundaries and/or domains thereof, govern the types, magnitude, and direction of heat transfer.

The flexibility of the universal wellbore reactor system configurations allows for the transformation of diverse categories of feedstocks while enabling the use of available resources within close proximity. Finally, universal wellbore reactor systems can be located at sites with favorable drilling conditions, or geothermal locations, or utilize existing well bores that are no longer productive, minimizing capital expense.

Accordingly in one embodiment the reactor system has one or more wellbore reactors for transforming a feed mixture into one or more product stream or one or more intermediate product outputs. The wellbore reactor extends downwardly through a subsurface formation by a distance that defines an elongated wellbore volume. The wellbore reactor has an elongated outer pipe and an elongated inner pipe that define a channel volume including an inner channel and an outer channel in a counterflow configuration. The counterflow configuration directs the feed mixture down one channel and upward through the other channel. The inner pipe, the outer pipe, or both are configured for heat transfer between the inner channel and the outer channel. The Inner channel, the outer channel or both the inner channel and the outer channel are made in part or completely of a ferromagnetic material that provides one or more ferromagnetic regions on all or a portion of the inner pipe and the outer pipe. The inner channel and the outer channel at least in part effect changes in temperature of the feed mixture as it passes through the channels. The depth of the counterflow configuration to which it extends into the borehole produces changes_in pressure of the feed mixture as it passes through the channels.

An optional middle pipe extends at least partially within the outer pipe to the outside of the inner pipe. At least a portion of the inner pipe and the middle pipe define a heat transfer annulus that extends between all or a portion of the inner pipe and the middle pipe. The well bore may also have an optional central rod that extends within the inner channel as a central conductor.

A protection annulus that lies to the outside of the outer piping on one side and typically to the wellbore on the other side will usually retain a heat transfer media. The heat transfer media will mostly regulate external heat exchange across the outer pipe;

A circuit return fixed to a lower portion of the inner piping provides a conductive path that usually includes a ferro-conductive region and will extend to a central conductor or the middle piping to complete an electrical circuit that utilizes one of them as a conductor.

At least one non-electro-conductive component fixed to at least a portion of at least one of the outer piping, the inner piping, the optional inner piping and the optional central conductor that inhibits the conduction of electrical energy between at least two ferromagnetic regions. At least a portion of the non-conductive component comprises a non-electroconductive structure fixed with respect to the inner pipe, the outer pipe, the optional middle pipe or the optional central conductor. An electro insulator is typically fixed to the inner pipe, the outer pipe, the optional middle pipe and/or the optional central conductor. A non-electroconductive heat transfer media is confined in part by the outer wall of the inner elongated conduit and/or the optional middle wall.

An electrical input point and an electrical output point are located to deliver and receive, respectively, electrical energy to or recover it from the inner pipe, the outer pipe, the optional middle pipe; and/or the optional conductor

A frequency generator adapted provide electrical energy to the ferromagnetic regions to produce a temperature of 20 to 760° C. in the inner channel and/or the outer channel.

In addition, input conduit and output channel each separately communicates with the inner channel and/or the outer channel of the wellbore reactor to respectively deliver a feed mixture to and recover from the wellbore reactor an input stream and an output stream from at least one well bore reactor.

### Wellbore Reactor Design

The universal wellbore reactor system comprises one or a series of wellbore reactors greater than 100 ft in depth and sealed from the subsurface formation (17) by the outer piping and/or the protection string, formed by reactor piping, comprising:
Inner piping (1): one or more segments of piping/tubing wherein the inner surface creates the outer radial boundary of the inner channel, and the outer surface creates the inner radial boundary of the outer channel or heat exchange annulus where appropriate
Outer piping (3): one or more segments of piping/tubing wherein the inner surface creates the outer radial boundary of the outer channel, and the outer surface creates the inner radial boundary of the protection annulus
Optional Middle piping (2): one or more segments of piping/tubing wherein the inner surface creates the outer radial boundary of the heat exchange annulus and outer surface creates the inner radial boundary of the of the outer channel
wherein energizable components, at least in part, establish the desired temperature profile. Energizable components as defined herein; components/piping of the wellbore reactor that create the electrical circuit comprising at least one of: nonmagnetic energizable components, that transfer energy at selected frequencies within the component without generating appreciable heat, and ferromagnetic energizable components (400), accept energy at selected frequencies and generates heat within the component therefore facilitating skin frequency heat transfer to the inner and/or outer channels. Energizable components create a complete electrical circuit that transfers energy to the desired locations where heat is needed, and when combined with the regional pressures thereof, achieves the conditions for the targeted and/or transformation reactions.

One or more feed mixtures and/or other types of reactor inputs enter the wellbore reactor at or near the surface, wherein the pressure and temperature can steadily increase as they flow down the heat exchange zone from hydrostatic pressure and internal heat transfer from the up flowing output. Once the downflowing input reaches the dropout chamber, the flow reverses upward via the opposite channel wherein the pressure gradually decreases with lessening hydrostatic head and temperature gradually decreases in regions without skin frequency heat transfer. In one embodiment, one or more reactor inputs enter the inner channel of the wellbore reactor at or near the surface and one or more reactor outputs exit the wellbore reactor via the outer channel at or near the surface. In another embodiment, one or more reactor inputs enter the outer channel of the wellbore reactor at or near the surface and one or more reactor outputs exit the wellbore reactor via the inner channel at or near the surface.

The flexibility of the universal wellbore reactor system is due to the many factors that determine overall and localized internal heat transfer, skin frequency heat transfer and external heat transfer, which ultimately determine the temperature profile within the reactor.

The thermo-fluidic dynamics within the inner and outer channel can be configured to facilitate the desired targeted and/or transformational reactions, in ways including but not limited to: selecting the piping diameter, configuring the type, quantity and location of the energized components, configuring the reactor depth; the use of one or more laterals; configuring the surfaces of piping in communication with the inner and outer channels; configuring the mechanisms and dynamics of internal heat exchange, skin frequency heat exchange, and external heat exchange; configuring the type and location of pressure control mechanisms within the wellbore. Thermo-fluidic dynamics as defined herein; the properties of the fluid that govern how the fluid in the inner and outer channel flows and interacts with heat and as such are governed by properties including but not limited to: temperature, pressure, velocity, density, heat capacity, thermal conductivity, viscosity, and other derivate values from those such as Reynolds number and Prandtl number.

Wellbore reactors may comprise two zones, a Heat Exchange Zone (HEZ), and a Skin Frequency Heater Zone (SFHZ). The HEZ (9) comprises the upper reactor region, wherein the internal heat transfer between the cool downflowing input and hot up flowing output is governed across their respective channels. The SFHZ (11) comprises ferromagnetic energizable components wherein skin frequency heating establishes and/or maintains transformation reaction temperature ranges.

Suitable universal wellbore reactors described herein have multiple configurations that effect how heat is generated and how heat is exchanged between the inner and outer channel.

### Wellbore Reactor With Heat Exchange Annulus

In embodiments comprising a wellbore reactor with heat exchange annulus, the magnitude of internal heat transfer across the inner and outer channels is governed through one or more heat exchange chambers (70) in the heat exchange annulus. A wellbore reactor with heat exchange annulus (205) comprises:
an inner channel (5), bounded by the inner surface of the inner piping (1)
a heat exchange annulus (6), electrically isolated from the inner and outer channel, bounded by the inner surface of the middle piping (2), the outer surface of the inner piping (1),
A solid circuit return (460) affixed on the lower regions of the inner and middle piping, that completes the electric circuit and seals the bottom of the heat exchange annulus
an outer channel (7), bounded by the inner surface of the outer piping (3), and the outer surface of the middle piping
a protection annulus (8), bounded by the inside surface of the inner protection string (4) and the outer surface of the outer piping

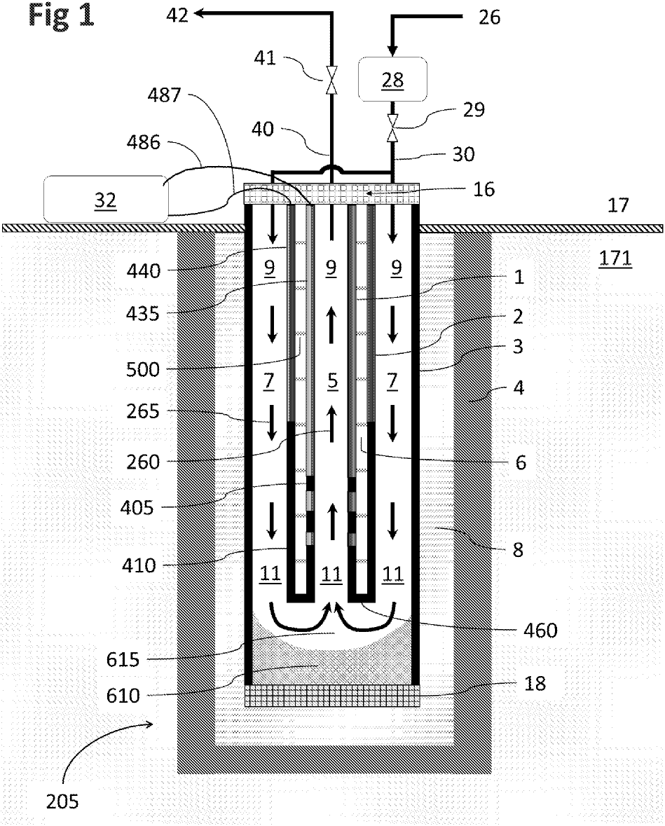

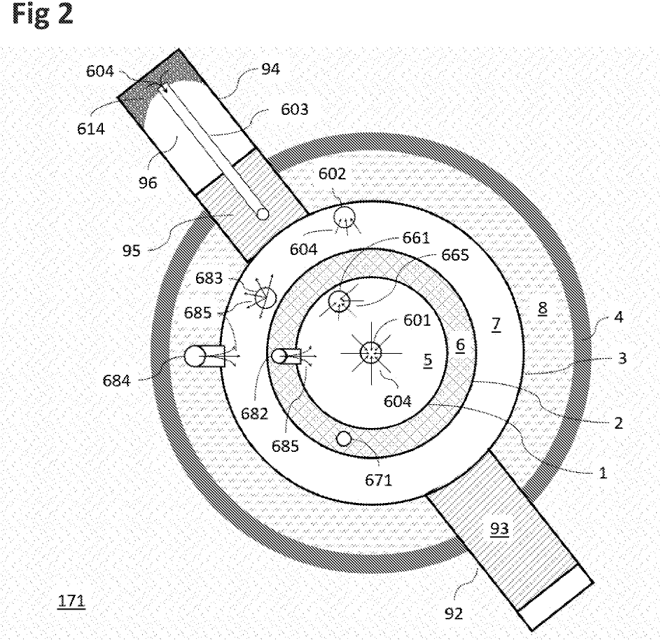

The energy input from the frequency generator (32) is connected to the inner piping (486) and middle piping (487) at or near the surface, wherein a solid circuit (460) return completes the hot and neutral electrical circuit, as shown in FIG. 1. Skin frequency heating of ferromagnetic energizable components is used to deliver skin frequency heat transfer to the inner channel (776) and/or outer channels (778) in one or more different configurations including but not limited to:

Similar lengths and locations of inner and middle ferromagnetic energizable components
Majority of the inner or middle piping comprises ferromagnetic energizable components
Only the inner or middle piping comprises the ferromagnetic energizable components
All of the inner and middle piping comprises ferromagnetic energizable components

The ferromagnetic material that provides the energizable components may be incorporated into the piping or the central conductor in a wide variety of ways and configurations. Any part of the piping or central conductor may provide or be made of ferromagnetic material. Locations where the ferromagnetic is provided may be referred to as ferromagnetic regions. Thus, ferromagnetic generally refers to all or a part of pipe or conductor containing ferromagnetic material. Thus, all or a portion of inner pipe or piping, the outer pipe or piping, the middle piping (when present) and/or the central conductor (when present) may provide a ferromagnetic region. Such regions may have the shape of cylindrical bands that extend fully or partially around the circumference of a pipe section; longitudinally extended and narrow arcuate sections of ferromagnetic material and even spiral sections of ferro material that wind fully or partially though pipe or piping. When a central conductor is present it preferably comprises non ferromagnetic material unless it is meant to generate heating. Again, the ferromagnetic region may constitute the entire inner pipe, the outer pipe, or a middle pipe. Preferably, the ferromagnetic region will be present in the form of full cylindrical band with a pipe or the piping. In such an arrangement one or both of the inner pipe, the outer pipe and middle pipe (if present) have more than one ferromagnetic region. When part of the wellbore reactor system, the entire central conductor will usually include ferromagnetic material over its full length.

Typically, any pipe or that piping will have a limited portion of ferromagnetic material incorporated into it and other portions of a pipe or the piping will comprise or consist essentially of a non-conductive material in a non-conductive region. The non-conductive region may take any of the shapes or forms as described in the previous paragraph.

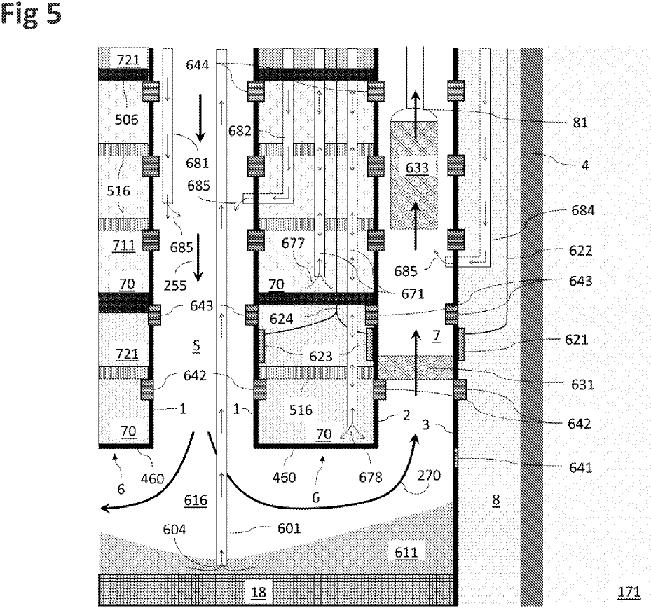

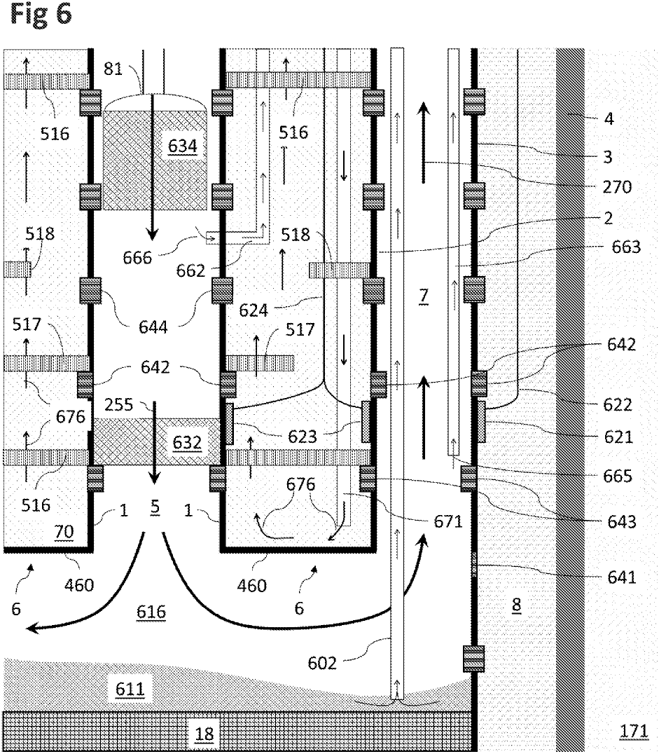

The heat exchange annulus is configured in a way that no electrical energy is conducted or otherwise transferred between the inner and middle piping prior to the solid circuit return. In one embodiment, an electro-insulator defined herein as distinct material domain, cladding, coating, or other form of deposition on one or more surfaces of the energizable components, that prohibits the conduction of electrical energy between the energizable components insulating domain, is in the heat exchange annulus. In another embodiment an electro-insulator (476) is on the outer surface of the inner piping and/or on the inner surface of the middle piping as shown in FIG. 6. In another embodiment, one or more heat exchange chamber(s) within the heat exchange annulus comprise a non-electroconductive heat transfer media. In another embodiment, non-electroconductive centralizers (500) defined herein as structure components that are affixed to one or more walls of the reactor piping that ensure no conduction of electrical energy due to the proximity of the energizable components, by centralizing and/or stabilizing them within their domains. As shown in FIGS. 5 and 6, the heat exchange annulus can be used to locate optional components including but not limited to:
reactor sensors (623) such as temperature, pressure, flow sensors; and/or any other measuring, monitoring or sensitive components, fiber optics, wiring or connections thereof (624).
One or more activator tubes (682) that delivers optional activators and/or reaction agents to the inner and/or outer channels.
One or more heat transfer tubes (671) that facilitates heat transfer flow (676), addition or removal (678) of heat transfer media.

### Wellbore Reactor With Direct Heat Exchange

In embodiments comprising a wellbore reactor with direct heat exchange, the magnitude of internal heat transfer across the inner and outer channels is transferred directly through the inner piping. These embodiments may be preferable when the level of heat transfer must be increased and/or when it is desirable to reduce the quantity of reactor piping. A wellbore reactor with direct heat exchange (210) comprises:
An optional central conductor (470) comprising a solid rod, tubular piping, stranded/bundled wires/cables in the inner channel
An inner channel bounded by the inner surface of the inner pipe and the outer surface of a central conductor where appropriate
An outer channel bounded by the inner surface of the outer pipe and outer surface of the inner pipe
A pass-through circuit return (465) that connects the lower regions of the energized components, that complete the electric circuit, that allows fluid in the inner channel or outer channels to pass through
A protection annulus, bounded by the protection string and the outer surface of the outer pipe.

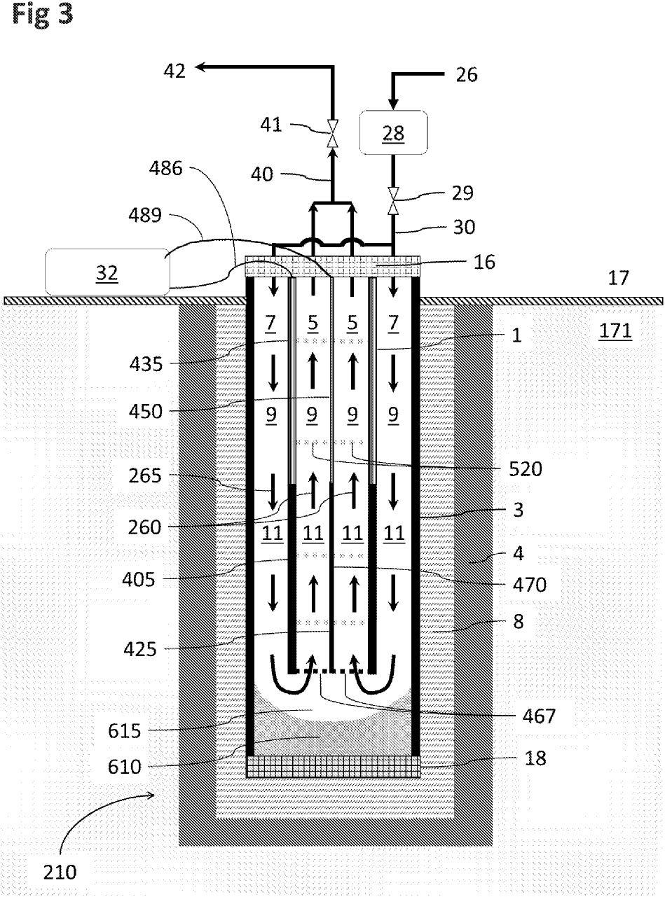

FIG. 3 shows one embodiment, wherein the energy input from the frequency generator (32) is connected at or near the surface to the inner pipe (486) and to the central conductor (489) comprising non magnetic (450) and ferromagnetic (425) regions, wherein the pass-through circuit return (467) extends inward from the inner pipe (1) through the inner channel (5) to the central conductor (470) to complete the electrical circuit.

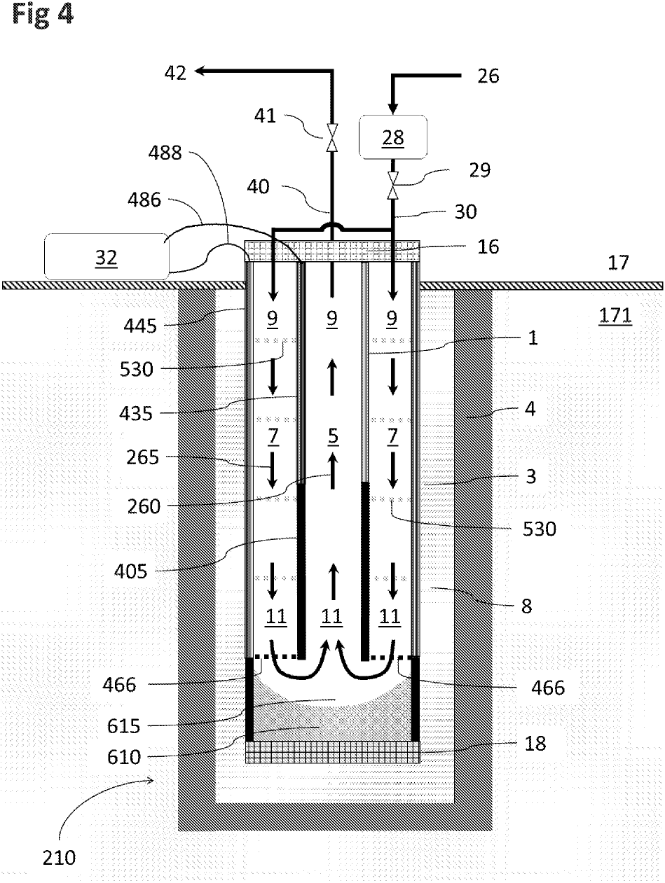

FIG. 4 shows another embodiment, wherein the energy input from the frequency generator (32) is connected to the inner piping (486) and outer piping (488) at or near the surface wherein the pass-through circuit return (466) extends outward from the inner pipe (1) through the outer channel (7) to the outer pipe (3) to complete the electrical circuit.

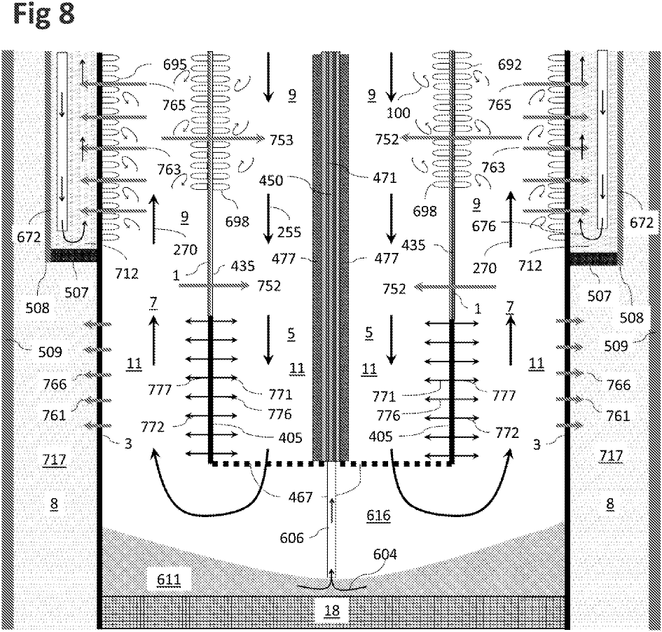

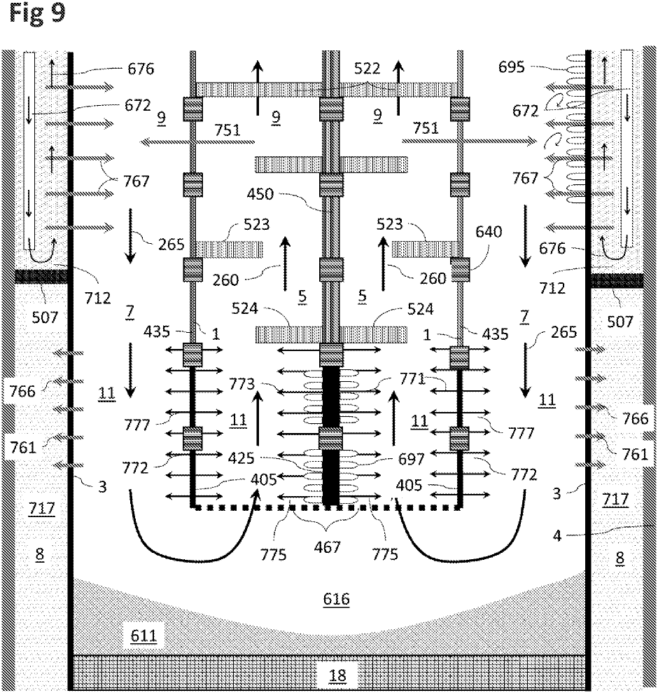

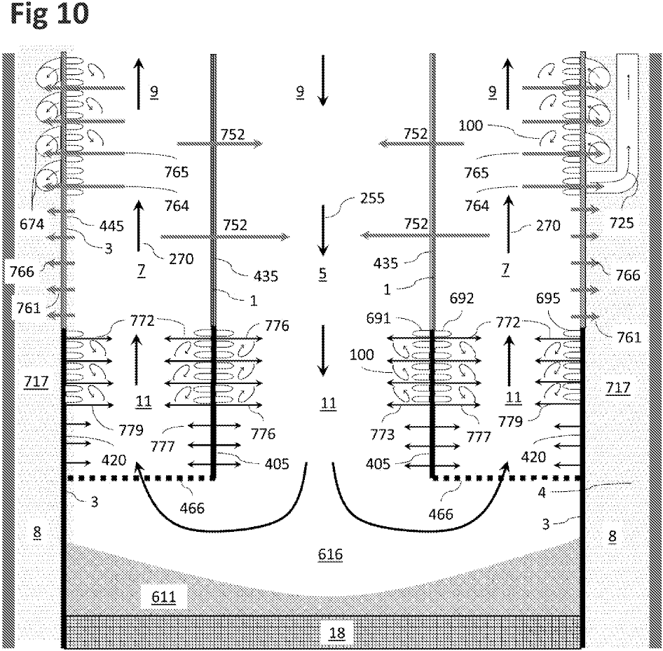

The temperature profile is, at least in part, determined by one of the following ferromagnetic energizable component configurations:
ferromagnetic inner piping (405) delivers skin frequency heat transfer to the inner channel (776) and outer channel (777), as shown in FIG. 8
ferromagnetic central conductor (425) delivers skin frequency heat transfer (775) to the inner channel, as shown in FIG. 9
ferromagnetic outer piping (420) delivers skin frequency heat transfer to the outer channel (779), as shown in FIG. 10

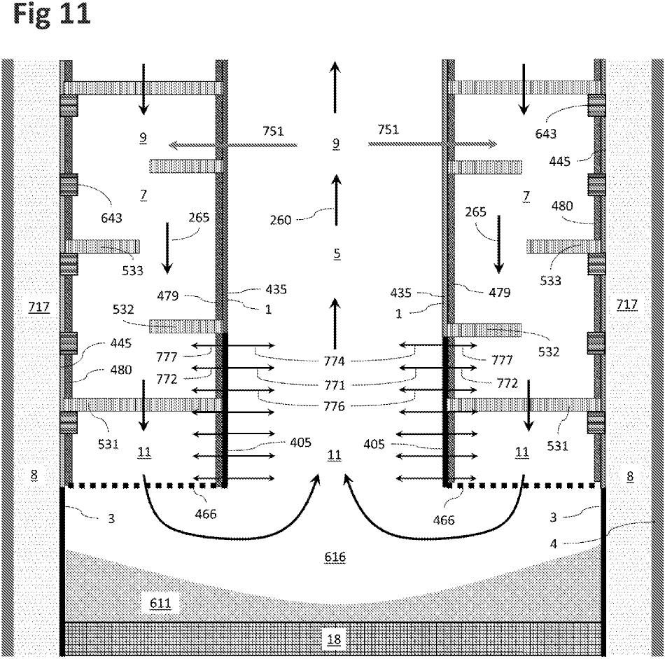

The energizable components are configured in a way that they are electrically isolated from each other, such that no conduction or other forms of electrical energy is transferred between them prior to the pass-through circuit return. In one embodiment, the inner and/or outer channels comprise fluids that do not conduct electrical energy between the energizable components. In another embodiment, pass-through centralizers are utilized to ensure there is no physical contact or other forms of electrical energy conduction between the energizable components, while allowing fluid flow in the inner and/or outer channels to pass through them. In another embodiment shown on FIG. 9, pass-through centralizers extend, at least in part, inward from the inner pipe (523) and/or outward from the central conductor (524), wherein they comprise part of the inner channel cross section, or all of the inner channel cross section (520). In another embodiment shown on FIG. 11, pass-through centralizers extend, at least in part, inward from the outer pipe (533) and/or outward from the inner pipe (532), wherein they comprise part of the outer channel cross section or all of the outer channel cross section (530). In another embodiment, an electro insulator is on at least a part of, the inner surface of the outer pipe (480), and/or the outer surface of the inner pipe (479), as shown in FIG. 11.

### Dropout Chamber

The wellbore reactors comprise a dropout chamber (615) as defined herein; a chamber at the maximum vertical length of the wellbore reactor, bounded below the circuit return, above the bottom seal (18), and between the outer piping wherein the flow is transferred to/from the inner and outer channels and to/from downflow and upflow, that optionally capture least a part of the precipitate (610).

The dropout chamber is the domain bounded below the circuit return, above the bottom seal, and between the outer piping, wherein the flow reverses from the downflowing input channel to the upflowing output channel. In another embodiment, the precipitate may fall out of solution and be collected in the dropout chamber.

In one embodiment, the dropout chamber has depths of less than 100 ft, or depths greater than 100 ft, or depths between 5-15% of total reactor length. In one embodiment, the dropout chamber comprises one or more vertical dropout chambers (616) wherein precipitate optionally accumulates (611) and/or one or more diagonal dropout chambers (617) wherein precipitate optionally accumulates (612) and/or one or more horizontal dropout chambers (618) wherein precipitate optionally accumulates (613).

### Reactor Tubes

The wellbore reactor may comprise optional reactor tubes as defined herein, small diameter tubing located in the inner channel, outer channel, heat exchange annulus and/or protection annulus, wherein fluidic media are transported from the surface to a desired location within the wellbore reactor, and/or fluids are extracted from a desired location within the wellbore reactor to the surface. Suitable types of reactor tubing include but are not limited to: small diameter tubing, small diameter piping, small diameter casing, capillary tubing, spooling tubing, string tubing.

In one embodiment, the one or more reactor tubes are at a fixed locations within the wellbore reactor. In another embodiment, one or more reactor tubes comprise capillary/spooling tubing in the inner and/or channel, wherein there location can be varied on the surface by techniques known in the art. In another embodiment, the variable reactor tubing can be varied by 0-100% of total reactor length, or 1-99%, or 10 to 90%, or 25 to 75%, or 33% to 67%, or 1% to 50%, or 2 to 40%, or 3 to 30% or 5 to 25%.

### Siphon Pipe

A siphon pipe is a type of reactor tubing, configured to transport precipitate that accumulates in vertical dropout chambers (611), diagonal dropout chambers (612), horizontal dropout chambers (613), and/or fishbone dropout chambers 614) chambers to the surface.

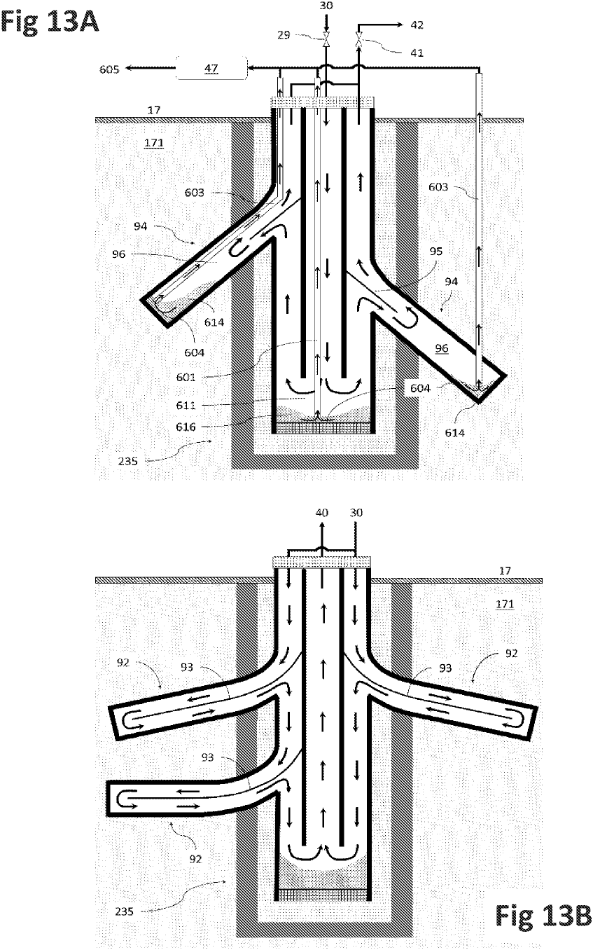

In one embodiment, one or more siphon pipes are located in the inner channel (601), outer channel (602), and/or dropout fishbone laterals (603), wherein a siphon control device (47) provides sufficient fluid dynamics to extract the precipitate out of their respective chambers to the surface (605), as shown in FIG. 13A. In another embodiment, the siphon control device works in conjunction with the output control device to provide sufficient fluid dynamics to facilitate precipitate extraction thereof. In another embodiment, the siphon control device has less restriction than the output control device (41) and extracts the precipitate in a continuous manner. In another embodiment, the siphon pressure control device operates in an intermittent, cyclic and/or pulsating fashion to remove the precipitate after a sufficient build up occurs. In another embodiment, pressurized fluid is pulsed or otherwise temporarily flows down the siphon pipe to fluidize or otherwise breakdown agglomerated precipitates, followed by subsequent upward extraction. In another embodiment, the siphon pipes remove the precipitate when the dropout chamber(s) are full and/or when the wellbore reactor is paused, idled and/or in any state of shutdown.

In another embodiment, the central conductor comprises tubing or otherwise serve as a siphon pipe (606), wherein the central conductor extends beyond the pass-through circuit connector (467), wherein these regions are no longer electroconductive, and precipitate is extracted (604) as shown in FIG. 8.

### Reaction Baskets

The wellbore reactor may comprise one or more optional reaction baskets as defined herein as a holding apparatus, resembling a cylindrical shaped basket, placed within the inner channel and/or outer channel. Reaction baskets contain reaction agents at a specific location(s) within the wellbore reactor to promote targeted and/or transformation reactions while avoiding undesirable reactions and/or denaturation that may be present elsewhere within the wellbore reactor. Furthermore, the containment of reaction agents within the reaction basket eliminates the requirement to separate them from the reactor output.

In one embodiment, one or more a fixed reaction basket axially comprises the entire cross section of the inner channel (632) and/or outer channel (631), wherein it is fixed to the respective piping with techniques known in the art such as band clamping, or utilizes sub joints, pipe couplers, or is otherwise located with other types of support mechanisms. In another embodiment, the fixed reaction basket is allowed to float between an upper and lower fixing mechanism thereof. In another embodiment, a variable reaction basket comprises an axial fraction of the inner channel (634) and/or or outer channel (633), wherein it secured by reaction basket hangers (81) suspended from tubing or cabling with techniques known in the art. In another embodiment, the vertical position of the variable reaction basket is controlled by techniques common in the art, such as a winch-type mechanism or hydraulic techniques, on the surface, allowing for the vertical adjustment of one or more reaction agents location.

In one embodiment, the reaction agents within the reaction baskets are replaced during prescheduled maintenance when the reaction baskets are brought to the surface and/or the reaction agents are suctioned from and filled back to reaction basket(s). In another embodiment, reaction basket hangers comprise variable reactor tubing, wherein position can be adjusted, and reaction agents can be added/removed as needed through the reactor tubing thereof.

### Laterals

The wellbore reactor may comprise one or more optional laterals as defined herein as one or more segments of reactor piping comprising a radius of curvature, wherein the wellbore reactor extends into the subsurface formation in a direction other than vertical. Laterals can be used to increase the reactor volume and/or residence time within a specific temperature and/or pressure range. In particular, laterals may be used wherein the pressure need to be kept within a desired range, when the pressure has reached a maximum desired range, and/or when increasing the reactor depth is otherwise counterproductive.

Laterals are constructed by horizontal drilling techniques common in the art, wherein the radius of curvature of the lateral changes at a rate of 1 degree for every 1-100 ft of piping. In one embodiment one or more laterals comprise a total horizontal length between 10% to 10,000% 20%-2000% of the total reactor length, or 30%-1000%, or 40%-500%. In another embodiment the lateral comprises a horizontal lateral (90) that is 90 degrees from vertical. In another embodiment, the lateral comprises a diagonal lateral (91) that between 1-89 degrees from vertical, or 10-80 °, or 25-75 °, or 33-67 °.

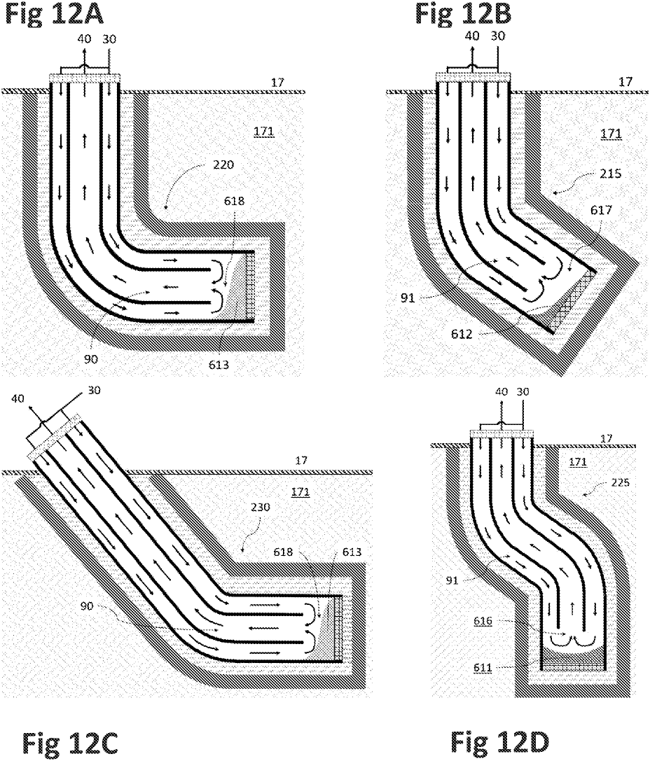

In one embodiment shown in FIG. 12A, a wellbore reactor with a horizontal lateral (220) comprises a horizontal lateral (90) at the maximum vertical depth, comprising a horizontal drop out chamber (618), which optionally captures precipitate (613). In another embodiment shown in FIG. 12B, a wellbore reactor with a diagonal lateral (215) comprises a diagonal lateral (91) at the maximum vertical depth, comprising a diagonal drop out chamber (617), which optionally captures precipitate (612). In another embodiment, a wellbore reactor with intermediate laterals (225) comprises one or more horizontal laterals and or one or more diagonal laterals at one or more intermediate vertical depths, followed by a return to vertical segments wherein total vertical depth is subsequently established. In another embodiment, a slanted wellbore reactor is at a diagonal angle, between 1-89 degrees from vertical, or 10-80°, or 25-75°, or 33-67°, and maintains the same angle throughout the total length of the wellbore reactor. In another embodiment, a slanted wellbore reactor comprises one or more angular changes, to become more horizontal, or more vertical, at one or more intermediate depths and/or at maximum vertical depth, as shown in FIG. 12D.

In another embodiment, laterals are positioned at a depth corresponding to favorable geothermal temperatures of the surrounding subsurface formations, wherein the cumulative magnitude of external heat transfer from the surrounding to the wellbore reactor is maximized. In another embodiment, the lateral is located at a depth wherein the surrounding subsurface formation is at least 50° C., or at least 75° C., or at least 100° C., or at least 125° C., or at least 150° C.

### Fishbone Laterals

The wellbore reactor may comprise one or more optional fishbone laterals as defined herein: one or more tubes that radially extend out from the outer channel, at one or more intermediate locations, wherein the flow in the outer channel, is at least in part, directed to down the lateral, and subsequently comes back up the lateral and re-enters the outer channel. Laterals can be used to extend the reactor volume and or residence time at a specific set of temperatures and pressures, wherein hydrostatic pressure and/or internal heat transfer have minimal impacts. Optionally, insulation can be placed on the outer surface of the fishbone lateral, to minimize external heat transfer to the subsurface formation. Laterals can be easily deployed at many independent depths and as such, are suitable for when the reactor volume and or residence time needs to be extended at several different conditions.

Fishbone laterals are constructed using drilling and completion methods known in the art for “fishbone well-design”. The diameter of the fishbone lateral piping is typically smaller than the protection string and the radius of curvature of the fishbone lateral (92, 94) changes 1 degree for every 1-100 ft of piping. In one embodiment, one or more fishbone laterals have a total length between around 10% to 10,000%, 20% to 2000% of the maximum reactor length, or 30%-1000% or 40%-500%, and are between 1-90 degrees from vertical, or 10-80°, or 25-75°, or 33-67 °. In another embodiment, more than one fishbone laterals are at different axial locations at the same, or similar depths typical to equipment limitations. In another embodiment, one or more fishbone laterals are at different vertical depths, wherein temperatures and pressures are representative of different targeted and/or transformation reactions.

In one embodiment, comprising a wellbore reactor with fishbone lateral (235), full diverters (93) facilitate, at least a portion of the flow from the outer channel into the full fishbone lateral piping (92), such that flow is in one domain, as defined by the Inner Diameter of the fishbone lateral and full diverter (93), then switches direction at the end of the full fishbone lateral and flows back towards the outer channel via the opposite domain, as shown in FIG. 13A. In another embodiment, comprising a wellbore reactor with fishbone lateral (235), partial diverters (95) facilitate, at least a portion of the flow from the outer channel into a portion of the dropout fishbone lateral piping (94), comprising a fishbone dropout chamber (96), such that flow direction reverses after the end of the partial diverter (95), as shown in FIG. 13B.

In one embodiment, one or more reaction agents and/or activators are delivered to the fishbone lateral. In another embodiment, comprising one or more dropout fishbone laterals, at one or more depths, one or more precipitates (614) are captured in the fishbone dropout chamber(s) (96). In another embodiment, one or more siphon pipe(s) (603) are used to remove the captured precipitate (604), as shown in FIG. 13B. In another embodiment, the fishbone dropout chamber (96) contains one or more reaction agents to neutralize, or otherwise convert the captured precipitate into non-hazardous and/or recoverable products.

### General Description of Transformation Reactions

The universal wellbore reactor system is configurable to facilitate the transformation reactions of feedstocks to recoverable products. Transformation reactions are as defined herein: the reactions that occur at range(s) of temperature(s) and/or pressure(s) that transform the feedstock and/or its intermediaries into the recoverable product and/or any precursors thereof.

Furthermore, transformation reactions may be assisted or otherwise furthered by one or more targeted reactions as defined herein: the reactions that occur at a targeted set of reactor conditions that facilitate singular mechanism; multi-step mechanism, chain mechanism and/or branching chain mechanism; or comprise one or more steps in an overall multi-stage/complex reaction. Targeted reaction(s) may aid the transformation reaction(s) and/or improve the quality of the recoverable product in ways including but not limited to the formation of desirable intermediates/precursors for the transformation reaction(s) and/or, desirable post transformation reactions.

Suitable transformation reactions are classified into categories comprising: Near Ambient Transformation (NAT), HyperThermal Transformation (HTT) and Super Critical Diluent Transformation (SCDT). Additional feedstocks, classifications of transformation reactions, and/or recoverable products can be facilitated, provided they are within the limitations of the Universal Wellbore Reactor System; 20-760° C. in temperature and the 1-6000 bar of pressure or 1-2000 bar, or 1-600 bar.

In one embodiment, one or more wellbore reactors are configured for NAT with a temperature and pressure between 20-90° C. and less than 200 bar, to facilitate various forms of biotic processes to produce renewable hydrocarbon products from hydrocarbon waste.

In another embodiment, one or more wellbore reactors are configured for HTT with a temperature and/or pressure below the critical point of the diluent(s) to facilitate the transformation of one or more feedstocks to one or more recoverable products. In another embodiment wherein the diluent comprises water, one or more wellbore reactors are configured for HTT between 250-372° C. and 50-500 bar, to facilitate the transformation of one or more feedstocks to one or more recoverable products.

In another embodiment, one or more wellbore reactors are configured for SCDT with a temperature and pressure above the critical point of the diluent(s) to facilitate the transformation of one or more feedstocks to one or more recoverable products. In another embodiment wherein the diluent comprises water, one or more wellbore reactors are configured for SCDT between 373-600° C. and 220-500 bar, to facilitate the transformation of one or more feedstocks to one or more recoverable products.

### Feedstocks

Suitable feedstocks comprise hydrocarbons and/or advanced materials selected from groups including but not limited to: animal manures, animal wastes/residues, agricultural wastes/residues, vegetation and its derivates, wood and its derivatives, municipal waste, municipal solid waste, industrial waste comprising hydrocarbons and/or valuable metallic compounds, mineral rich resources, and/or other forms of wastes, byproducts, or products with limited use and/or economic value. As such, suitable feedstocks have molecular composition in categories including but not limited to:
Hydrocarbon waste comprising: ligno-cellulose, lignin, cellulose, hemicellulose, sugars, starches, proteins, fatty acids, lipids, fats, waxes, paraffins, plastics, monomers, polymers, long chain polymers, oligomers, and/or other hydrocarbon components from waste sources.
Low quality hydrocarbons comprising: solid heavy hydrocarbons, liquid heavy hydrocarbons, hydrocarbons with metallic contaminants/pollutants, ligno-cellulose, lignin, cellulose, hemicellulose, sugars, starches, proteins, fatty acids, lipids, fats, waxes, paraffins, plastics, monomers, polymers, long chain polymers, oligomers
Metallic entrained wastes comprising: light Rare Earth Elements (REE), medium REEs, heavy REEs, critical materials, precious metals and/or other wastes comprising advanced materials, and/or valuable metallic/inorganic components.
Mineral rich resources comprising: Light REEs, medium REEs, heavy REEs, critical materials, precious metals and/or other resources of advanced materials, and/or valuable metallic/inorganic components In some embodiments, the feedstock comprises water content that, at least in part, serves as a diluent. In many cases the solids are transferred through the system as a fluid transported solid.

### Hydrocarbon Feedstocks

In one embodiment, the hydrocarbon feedstock comprises agricultural waste. In another embodiment, the agricultural waste comprises animal manures including but not limited to: bovine, swine, poultry, goat, sheep, horse, llama, rabbit, or other type of farmed, grazing and/or flocking animals. Furthermore, animal manures may comprise water content that is suitable for at least a part of the diluent, wherein water comprises approximately 30% to 90% of the total feedstock ma mass. Finally, animal manures may comprise the biotic microorganisms suitable for NAT embodiments. In another embodiment, the agricultural waste comprises crop silage, as defined as the left-over plant mass from agricultural operations and/or harvesting. Suitable types of crop silage include but not limited to groups comprising: grasses, straw, stems, stover, husk, cobs, and shells from wheat, rye, corn, rice, sunflowers; empty fruit bunches from palm oil production, palm oil manufacturers effluent, pome, bagasse; wine waste; greenhouse waste, garden waste, and weeds.

In another embodiment, the hydrocarbon feedstock comprises forest residues, as defined as the waste and/or left-over biomass from harvesting trees or other forms of clearing and maintenance of plant/vegetation growth. Suitable types of forest residues include but not limited to groups comprising, wood, scrap wood, wood chips, wood pellets, sawdust, forestry thinnings, bark, and leaves.

In another embodiment, the hydrocarbon feedstock comprises energy crops, defined as commonly grown and/or harvested crops, microorganisms, or other components rich in lignocellulosic and/or hydrocarbon components, with limited market, value, function and/or diminished demand, that are suitable for the conversion to bioenergy products. In one embodiment, suitable types of energy crops are grown, and used as a direct feedstock, and include but not limited to groups comprising: jatropha, sorghum, switchgrass, miscanthus, aquatic biomass, algae, macroalgae, microalgae, bacterium, biota and/or other micro-organisms. In another embodiment, products harvested from energy crops are used as suitable feedstocks including but not limited to: corn, corn kernels, sugar cane, beets, vegetable oil, palm oil, and/or soy oil.

In another embodiment, the hydrocarbon feedstock comprises heavy hydrocarbons including but not limited to groups comprising: bitumen, asphaltene, heavy oil, residual oil, tar, oil residues and oil sands, coal, lignite or any other heavy non-renewable or petroleum-based hydrocarbon with limited market, value and/or diminished demand. Heavy hydrocarbons can be used to supplement other forms of hydrocarbon feedstocks between 1-75 wt% with respect to dry hydrocarbon feedstock mass, or 10-75 wt%, or 25-75 wt%, or 50-75 wt%, or 10-67 wt%, or 15-50 wt%, or 5-33 wt%, or < 25 wt%, or < 15 wt%.

### Municipal Waste Feedstocks

In another embodiment, the feedstock comprises municipal waste as defined as the left-over components from the consumption and/or use of products. Municipal waste feedstocks may comprise hydrocarbon waste and/or metallic entrained wastes comprising advanced materials, their components and/or precursors thereof. Municipal waste feedstocks have many formats, such as liquids, aqueous fluids, slurries, particulate solids, and bulk solids. In some embodiments, the municipal waste comprises water content that, at least in part, serves as a diluent.

In one embodiment, the municipal waste comprises hydrocarbon waste representative of treated wastewater, including but not limited to groups comprising: aerobic and anaerobic digested sludges like, sewage sludge from wastewater treatment and/or digested sludge from bio gasification, clarifier sludge, biodegradable waste, or other forms of sewages.

In another embodiment, the municipal waste comprises municipal solid waste, as defined by products, materials and/or components that have reached the end of their useful life, serve no functional purpose, are in the process of being disposed of, or otherwise have previously been disposed of. Suitable types of municipal solid waste include but not limited to groups comprising:
Hydrocarbon waste such as: recycled materials such as plastics, paper products, cardboard, tires, and other types of generally discarded and/or recyclable materials
Metallic entrained wastes comprising advanced materials, valuable metallic/inorganic components and/or precursors thereof, such as: electronic waste, batteries, compact fluorescent lightbulbs, hard drives, general discarded and/or recyclable materials comprising advanced materials.

In another embodiment, the feedstock comprises industrial waste, defined as the byproducts from existing processes and/or production activities. Industrial waste may comprise hydrocarbons and/or metallic entrained wastes comprising advanced materials, their components and/or precursors thereof. Industrial waste has many forms, such as liquids, aqueous fluids, slurries, particulate solids, and bulk solids. In some embodiments, the industrial waste comprises water content that, at least in part, serves as a diluent.

In one embodiment, the industrial waste comprises hydrocarbon rich industrial waste, defined as the residues, byproducts and/or other types of left-over material from industrial processes that are rich in hydrocarbon, hydrogen and/or carbon compositions. In another embodiment, suitable types of hydrocarbon rich industrial waste are representative as the residues, byproducts, and/or waste from chemical/industrial process, including but not limited to groups comprising: organic solvents, glycerin, petroleum coke, refinery coke, refinery wastes/residuals, recycled asphalt, paper waste, black liquor from paper production, and/or other industrial chemical and/or processing aids. In another embodiment, suitable types of hydrocarbon rich industrial waste comprise food processing waste, as defined as the left-over plant, animal, or biotic components from the processing of food or beverages, and can be in the form of solids, liquids or slurries. Suitable types of food processing including but not limited to groups comprising residues and byproducts from:
fruit and vegetable processing/production activities such as olive, juice, wine, various types of vegetable oils;
fermentation processes such as brewer’s spent grains and yeast, wet distillers’ grain, vinasse, molasses;
animal processing waste such as: slaughterhouse waste, meat and bone waste, dairy waste, milk waste, restaurant waste, recycled oils and fats.

In another embodiment, the industrial waste comprises metallic entrained industrial waste, defined as the residues byproducts and/or other types of left-over material from industrial processes that are rich in advanced materials and/or minerals, components and/or precursors thereof. Suitable types of metallic entrained industrial waste include but are not limited residues byproducts, and/or waste from:
mine residues: mine tailings or mine wastes from the production of kaolin, phosphates, heavy mineral sands, ionic clays, iron oxides, coal
combustion byproducts: fly ash, coal ash, other combustion byproducts
raw materials producers: byproducts from producers of raw materials, electronics/circuit boards, magnets, or the byproducts from other types of advanced productions.
other waste components rich in advanced materials and/or minerals, such as spent catalysts, valuable metallic/inorganic components and/or precursors/intermediates thereof.

### Mineral Rich Resources

In another embodiment, the feedstock comprises one or more mineral rich resources defined as the concentrated ores, low concentration ores, salts, or other such traditional mining operation products, which are destined for further processing such as chemical or leaching operations. Suitable types of metallic mineral rich resources include but are not limited to groups comprising:
Ores or fluids comprising: Light REEs, medium REEs, heavy REEs, critical materials, precious metals
Ores or fluids including but not limited to: monazites, chalcopyrite, galena, stibnite, magnetite, hematite, quartzes, fluorites, calcites, pyrrhotites, sphalerites, phosphate bearing ores

### Diluent

One or more diluents are selected for the specific feedstock and the desired transformation reactions. Suitable diluents facilitate the dispersion, dissolution and/or suspension of the feedstock. In some embodiments, diluents have a high heat capacity, wherein diluent acts as a heat transfer agent to supply the thermal energy to reduce the size, complexity and/or break down the feedstock’s molecular structure, resulting in simple compounds, free radicals and/or other suitable mediums and/or reactants for targeted and/or transformation reactions.

In other embodiments, comprising HTT and SCDT transformations, diluents may have solubility properties sufficient to, at least in part, dissolve the feedstock, its subsequently reduced molecular components and/or free radicals, as they are formed. In other embodiments comprising hydrocarbon feedstocks, diluents may create a caging and/or dispersion effect, which inhibits unconstrained reactions and/or forms stable components. In other embodiments, comprising the production of renewable hydrocarbon products, diluents may serve as a hydrogen donor, wherein the cracked hydrocarbons and free radicals extract hydrogen from the diluent(s) and/or the diluent(s) facilitates hydrogen donation from other mechanisms.

In one embodiment, the diluent primarily comprises water. In another embodiment, the diluent(s) comprises one or more groups of liquids: water, solvents, alcohols, liquid organics, liquid hydrocarbons, acids, organic acids, bases, aromatics, phenols, salts, gases or any other compound or series of compounds that facilitates the desired function(s) of diluent.

In one embodiment, one or more diluents have a feedstock dry mass:diluent ratio between 1:25 to 5:1, or between 1:10 to 2.5:1, or between 1:5 to 2:1 or 1:3 to 1.5:1. In one embodiment, the diluent is, at least in part, added as a direct (21) and/or recycled (58) input. In another embodiment, wherein the diluent primarily comprises water, the diluent is, at least in part, present in the feedstock.

### Activator

One or more optional activator(s) may be added to improve at least one reaction mechanism and/or reactor dynamic comprising:
Reactor performance, such as: aid in the dissolution of the feedstock into the diluent; aid desirable reaction mechanisms; restrict undesirable reaction mechanisms; facilitate localized exothermic reactions; and/or increase yield of the renewable hydrocarbon product
Quality of the product output (42, 43) such as: increase the energy content; increase the Hydrogen:Carbon ratio; decrease the oxygen content; scavenging undesirable compounds or inorganics, and/or further reduce encapsulating structures of the recoverable product thereof.

In one embodiment, activators comprise, liquid and or aqueous fluids, that comprise soluble and/or liquid hydrocarbons from groups including but not limited to: alcohols, polyalcohols, cyclic hydrocarbons, aromatics, polyaromatics, phenols, polyphenols, phenolic acids, carboxylic acids, amino acids, lignin monomers, ketones, aldehydes, esters, ethers, amines, amides, pyrroles, indoles, catechols, alkanes, alkenes, alkynes, formaldehydes, acids, bases, solvents, organic acids, organic bases, organic solvents, or any other soluble/liquid hydrocarbon radical or reaction intermediary.

In another embodiment, activators comprise gases from groups including but not limited to: hydrogen, methane, ethane, propane, carbon monoxide, carbon dioxide, and/or any other light hydrocarbon gas compound that is suitable for hydrogen donation, carbon donation and/or oxygen reduction.

In another embodiment, activators comprise inorganic components from groups including but not limited to: perchlorates, oxides, peroxides, ammonias, nitrites, nitrates, halogens, or any other inorganic compound or intermediary thereof, that function as an activator.

Suitable levels of activators depend on their composition, intended function, delivery mechanism, and reactor conditions, but generally comprise levels between 0-25 wt% with respect to the dry feedstock, or 0.1-15 wt%, or 0.5-7.5 wt%, or 1-5 wt%. In one embodiment, the activator is obtained as a pure or otherwise direct raw material (24). In another embodiment, the activator comprises a mixture of many activators that are, at least in part, separated from the product output (42, 43), and recycled back to the wellbore reactor (58, 63).

In one embodiment, the feed mixture comprises one or more activators. In another embodiment, one or more activators are a direct input to the wellbore reactor. In another embodiment, wherein one or more activators require a specific temperature and/or pressure to function, they is delivered to a location in the wellbore reactor, wherein suitable conditions exist. In another embodiment, one or more activators is added to the inner channel (685) via one or more reactor tubing in the inner channel (681) and/or in the heat exchange annulus (682). In another embodiment, one or more activator is added to the outer channel (685) via one or more reactor tubing in the heat exchange annulus (682), in the outer channel (683), and/or in the protection annulus (684). In another embodiment, one or more variable reactor tubes, delivers one or more activators to configurable locations in the inner and/or outer channel

### Reaction Agents

One or more optional reaction agents are used to improve at least one reaction mechanism or reactor dynamic comprising:
Reactor performance, including but not limited to: reducing residence time of targeted reactions and/or transformation reactions; unlocking, accelerating, and/or aiding desirable reaction mechanisms; restricting and/or retarding undesirable reaction mechanisms; facilitating localized exothermic reactions; and/or improving yield of the desired recoverable product
Quality of the product output (42, 43) including but not limited to: scavenging undesirable compounds or inorganics; increasing the energy content; increasing the hydrogen:carbon ratio; decreasing the oxygen content; improving the stability; and/or improving the compatibility within existing fuel delivery systems or combustion systems
and are selected from one or more groups including but not limited to: Biotic organisms and/or enzymes; Simple catalysts such as comprising potassium, sodium, zinc, silicon, phosphorus, potassium carbonate, sodium carbonate, and zeolites; Functional metal catalysts comprising copper, indium, nickel, palladium, platinum, nobelium, titanium, aluminum, iron, zirconium, yttrium, silver, tin, ruthenium, gallium, cesium, molybdenum; Other alloys, other advanced catalysts, or other catalytic mediums; known in the art for biomass conversions, and/or in chemical/petrochemical industries, or yet to be divulged, that function as a reaction agent.

Suitable levels of reaction agents depend on their composition, intended function, format/state (e.g. solid, liquid or gas), delivery mechanism, and reactor conditions, but generally comprise levels are around 0.01-10 wt% with respect to the dry feedstock mass input rate or with respect to the dry feedstock mass present in the reactor volume, or 0.1-7.5 wt%, or 1-5 wt%. In one embodiment, the reaction agent is obtained as a pure or otherwise direct raw material. In another embodiment, the reaction agent is recovered, at least in part, from the product output, optionally regenerated, and recycled back to the wellbore reactor (53).

In one embodiment, the feed mixture comprises one or more reaction agents. In another embodiment, the reaction agent is a direct input to the wellbore reactor. In another embodiment, the reaction agent is added to the inner channel (685) via activator capillary tubing in the inner channel (681) and/or in the heat exchange annulus (682).

In one embodiment, wherein the reaction agent requires a specific temperature and/or pressure to function, it is delivered to a location in the wellbore reactor, wherein suitable conditions exist. In another embodiment, the reaction agent is added to the outer channel (685) via activator capillary tubing in the heat exchange annulus (682), in the outer channel (683), and/or in the protection annulus (684). In another embodiment, the reaction agents are held in reaction baskets at fixed locations in the inner channel (631) and/or the outer channel (632). In another embodiment, the reaction agents are held in reaction baskets, wherein basket hangar (81) varies the locations of the basket within the inner channel (634) and/or the outer channel (633). In another embodiment, wherein the reaction agents comprise functional metals, they are cladded to and/or deposited on the surfaces of the inner, middle and/or outer piping. In another embodiment, reaction agents are representative of, cladded, to and/or deposited on the surfaces of piping modifications (698)

### Recoverable Product

Suitable recoverable products produced from the wellbore reactor include but not limited to:
Renewable hydrocarbon products such as: crude oil substitutes, substitutes for final fuels, components of petroleum products, combustible hydrocarbon gases, hydrogen, organic solvents, and/or other hydrocarbon components/byproducts of value
Advanced materials such as: Rare Earth Elements (REE), critical materials, precious metals, advanced carbon, components useful for fertilizers and/or other inorganic components/byproducts of high function, high demand and/or high value.

In one embodiment, recoverable products are in one or more liquid phases, and include but not limited to groups comprising:
crude oil substitutes such as: biocrude, bio-oil, or any other compounds with properties facilitating the refining/separation into final fuels and/or other petroleum-based products/precursors.
substitutes for final fuels such as: gasoline, diesel, jet fuel, kerosene, fuel oils, boiler oils, bunker oils, or other hydrocarbons that have established use as combustible fuels
components of petroleum products such as: heavy gas oils, gas oils, light gas oils, vacuum gas oil, atmospheric bottoms, residues, vacuum residues, heavy distillates, distillates, light distillates, heavy straight run, light naphtha, heavy naphtha, sweet naphtha, olefins, alkylates, butane, pentane, hexane, heptane, octane, ethanol, methanol; or any other C4-C100 hydrocarbons that comprise final fuels or are otherwise associated with final fuels and/or other petroleum based products/precursors.
Alcohols, solvents; or any other liquid organic compounds, precursors and/or byproducts of value
Liquid/Aqueous components of advanced materials

In another embodiment, recoverable products are in one or more gas phases, and include but not limited to groups comprising
Combustible hydrocarbon gases such as: methane, ethane, propane
Hydrogen gas, concentrated hydrogen gas, purified hydrogen gas,
Vapor fraction of components and/or organic compounds including but not limited to: alkanes, alkenes, alkynes, alcohols, ketones, cyclic hydrocarbons, acids, aldehydes, esters, ethers, amines, amides, indoles, or any other organic compound, hydrocarbon radical or reaction intermediary with a vapor fraction
Other or gaseous components, precursors and/or byproducts of value, including but not limited to: hydrogen sulfide, nitrous oxide, sulfur oxide, carbon dioxide, carbon monoxide

In another embodiment, recoverable products are in one or more solid phases, comprising molecules, compounds, precipitates, char, solid molecular structures, encapsulations, intermediates, and/or other forms of precursors for separation/purification processes and include but not limited to groups comprising:
Advanced materials comprising groups including but not limited to:
   Light REEs: Lanthanum, Cerium, Praseodymium, Neodymium, Promethium,
   Medium REEs: Samarium, Europium, Gadolinium
   Heavy REEs: Terbium, Dysprosium, Holmium, Erbium, Thulium, Yttrium, Scandium, Ytterbium, Lutetium
   Critical materials: Vanadium, Chromium, Manganese, Cobalt, Nickle, Copper, Zinc, Rubidium, Strontium, Zirconium, Molybdenum, Cadmium, Antimony, Barium, Mercury,
   Precious metals: Gold, Silver, Platinum, Palladium, Ruthenium, Rhodium, Osmium, Iridium, Rhenium, Indium,
   Advanced carbon: Graphite, graphene, or other solid carbon-based components and/or precursors
   Other valuable insoluble/metallic components, byproducts, precursors and/or intermediates
Inorganic components useful as a fertilizer such as: Nitrogen, Phosphorus, Potassium

### DETAILED DESCRIPTION OF UNIVERSAL WELLBORE REACTOR SYSTEM

Universal wellbore reactors described herein have two zones, a Heat Exchange Zone (HEZ), and a Skin Frequency Heater Zone (SFHZ) and are capable of accepting total volumetric reactor inputs of around 0.1 to 25,000 m³/day, or 10 to 20,000 m³/day, or 50 to 15,000 m³/day or 100 to 10,000 m³/day, or 500 to 7,500 m³/day, or 0.1 to 1,000 m³/day, or 1 to 750 m³/day, or 5 to 500 m³/day, or 10 to 250 m³/day to facilitate the transformation of feedstocks to recoverable products.

Wellbore drilling techniques common in the art create an elongated wellbore into the subsurface formation with sufficient diameter to incorporate protection strings with an outermost diameter ranging from 3-144 inches, or 6-96″, or 9-72″, or 12-60″, or 14-48″, or 15-36″, or 3-15″, or 4-12″, or 6-60″ or 7-48″ or 8-40″ or 9-36″ or 10-30″. Protection strings (4) are defined herein as one or more pipes, casings and/or cement boundaries that may have multiple protection annuli within, that may individually extend to various depths/lengths, such that the wellbore reactor is encompassed and sealed from the surrounding subsurface formation(s)

Reactor piping as defined herein comprises one or more segments of pipes, tubing, casing, channels, and/or other types of components that provide an axial boundary to fluid flow, and comprise the inner piping, middle piping and outer piping. Individual segments of reactor piping are joined with one or more pipe couplers common in the art and can be non-upset (641); or protrude out from the outer surface of the pipe (642); or protrude out from the inner surface of the pipe (643); and/or protrude inward and outward from the pipe (644). In another embodiment, threaded pin and box pipe, welded, laser welded or RF welded pipe configurations are suitable pipe joining techniques.

The outer piping has an inner diameter between around 2-132 inches, or 4-90″, or 8-68″, or 10-56″, or 12-44″, or 14-32″ or 2-12″ or 3-10″ or 4-9″ or 5-8″ or 6-36″ or 7-30″ or 8-24″ or 9-20″ or 10-18″.

The inner piping has a inner diameter between around 0.1-100″, or 0.25-72″ or 0.33-44″ or 0.5-36″ or 0.67-24″ or 0.75″-18″ or 1-12″ or 1.5-9″ or 0.1-9″ or 0.5-6″ or 1-4″ or 0.75-12″ or 1-10″ or 1.5-8″ or 2-7″.

For embodiments comprising a wellbore reactor with heat exchange annulus, the heat exchange annulus has a width between around 0.01-9 inches, or 0.05-6″, or 0.1-5″, or 0.2-3″, or 0.5-2.5″ as measured from the outer diameter of the inner pipe and inner diameter of the middle pipe.

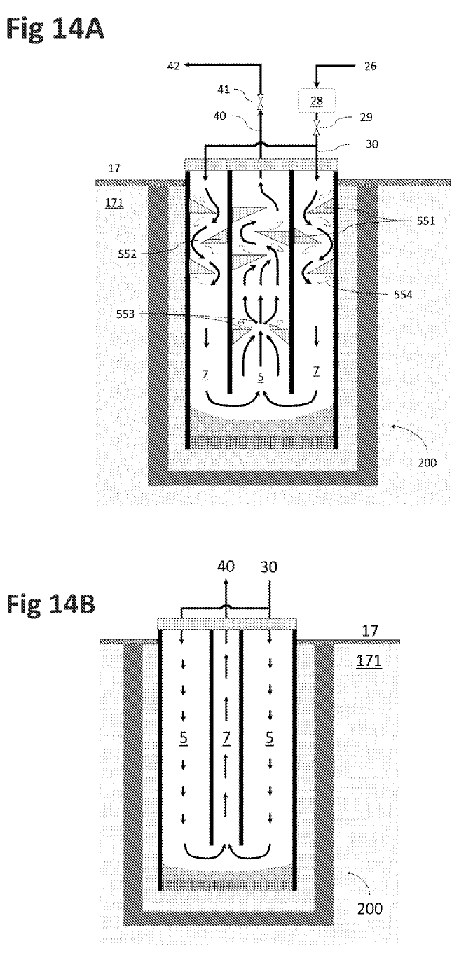

In one embodiment, the diameters of the inner, outer, and optionally middle piping are such that the cross-sectional area of the inner and outer channels are within approximately 33% of each other, to give similar flow rates and residence times within the upflowing and downflowing channels thereof. In another embodiment, as shown in FIG. 14B, the diameters of the inner, outer, and optionally middle piping are sufficiently different, to give different flowrates and residence times between the upflowing and downflowing channels thereof. Suitable flow rates in the inner and outer channel range between around 0.01-50 m/s, or 0.1-20 m/s, or 0.2-15 m/s, or 0.3-10 m/s, or 0.5-7.5 m/s.

### Thermofluidic Dynamics Control

Wellbore reactors comprise a Heat Exchange Zone (HEZ) and/or a Skin Frequency Heater Zone (SFHZ) wherein energizable components transfer energy at selected frequencies without and with skin frequency heat transfer respectively. In one embodiment, the HEZ comprises the upper reactor region, wherein internal heat transfer occurs between cool downflowing input, which could be located in the inner (255) or outer (265) channel and hot up flowing output, which could be located in the outer (270) or inner (260) channel. In another embodiment, the SFHZ comprises the lower reaction region, wherein skin frequency heat transfer from ferromagnetic energizable components establishes and/or maintains transformation reaction temperature ranges. In one embodiment, the entire wellbore reactor comprises ferromagnetic energizable components, wherein the temperature profile is governed by both internal heat transfer and skin frequency heat transfer. In another embodiment, the entire wellbore reactor comprises nonmagnetic energizable components, wherein the temperature profile is governed by both internal heat transfer and skin frequency heat transfer.

The types, direction, and magnitude of heat transfer within the wellbore reactor is a cumulation of thermodynamic mechanisms including but not limited to: conduction, convection, forced convection, flow convection, heat transfer dynamics at boundaries of adjacent domains, viscous dissipation/heat/work, volumetric expansion/compression, heat transfer flow and/or radiation. The dynamics of heat transfer and the resulting temperature profile within the reactor are governed by factors of the reactor design, feed/reaction conditions, and/or other forms of process controls including but not limited to: the reactor input temperature, pressure and flow rate; magnitude of skin frequency heat transfer as determined by the output of the frequency generator and configuration of ferromagnetic energized components; inner & outer channel cross sectional area and flow velocities thereof; thermofluidic dynamics within the reactor; the temperature difference between the inner and outer channels; and/or piping modifications and/or downhole pressure control devices that modify fluid dynamics.

### Heat Transfer Media

Amongst other variables, heat transfer media as defined herein, are materials within the protection annulus and/or one or more heat exchange chambers, that govern the magnitude of internal heat transfer and external heat transfer within their respective domains. For embodiments comprising wellbore reactors with direct heat exchange, heat transfer media governs the degree and magnitude of external heat transfer through the protection annulus. For embodiments comprising wellbore reactors with heat exchange annulus, heat transfer media governs the magnitude of internal heat transfer through one or more heat exchange chamber(s) within the heat exchange annulus and the magnitude of external heat transfer through the protection annulus.

In one embodiment, the heat exchange media comprises conductive heat transfer media in the protection annulus (707) and/or in one or more heat exchange chambers (706), wherein it facilitates a high degree of heat transfer across its respective domains. Suitable types of conductive heat exchange media include but are not limited to: aluminum, copper, steel, carbide, beryllium oxide, or any other solids with high thermal conductivity greater than 100 W/m K

In another embodiment, the heat exchange media comprises fluidic heat transfer media in the protection annulus (712) and/or in one or more heat exchange chambers (711), wherein it is a flowable material comprising a liquid, gas, suspended solids, granular solids, and/or a porous solid comprising a fluid within its porosity, such that heat transfer across its respective domains are controlled by conductive heat transfer, convective heat transfer, and optionally radiative heat transfer. Suitable types of fluidic heat transfer media include but are not limited to: liquids such as water, oil, mineral oils, polyolefins; gasses such as air, nitrogen, argon, sulfur hexafluoride or other inert gases, flowable solids such as high porosity and/or granular materials such as: sand; and or fluids that undergo thermodynamic phase transformation, or are refrigerants

In one embodiment, the fluidic heat transfer media is stagnant such that it has no flow, velocity, or other forms of convective properties. In another embodiment, the fluidic heat transfer media has no external force or energy to induce flow, velocity, or convection. In another embodiment, heat transfer flow of the fluidic heat transfer media is generated by buoyancy induced natural convection (679) from the temperature differences of the respective domains.

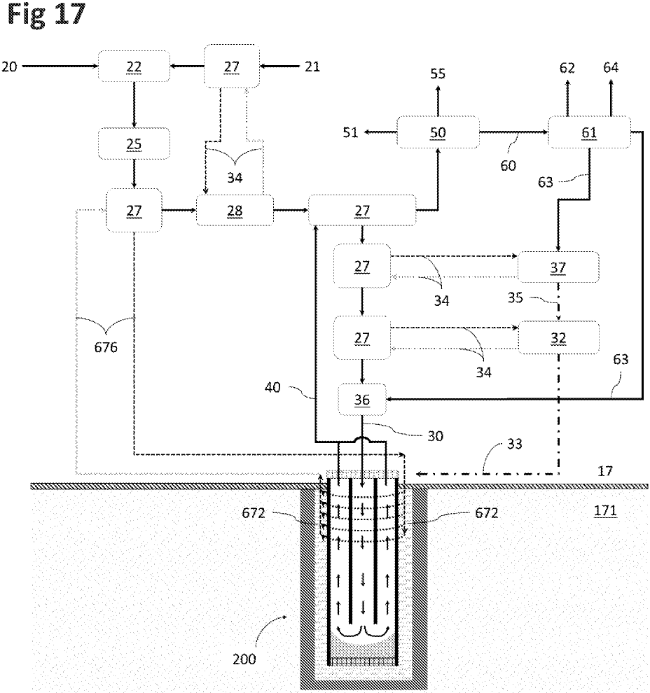

In another embodiment, heat transfer flow is generated by the discharge of a pump or other fluid transfer device. In one embodiment, the input and/or output of the fluidic heat transfer media to/from its respective domain is at or near the surface. In another embodiment, fluid directional components such as baffles, are used to direct the vertical and/or radial heat transfer flow within its respective domain. In another embodiment, the input and/or output of the fluidic heat transfer media to/from its respective domain utilizes one or more discharges from the heat transfer media tubing within the protection annulus (672) and/or within one or more heat exchange chambers (671). In another embodiment, the discharge of a pump or other fluid transfer device is in a pulsing fashion (677). In another embodiment, the discharge of a pump or other fluid transfer device is with positive displacement (676), such that the fluidic heat transfer media is transported into and/or out its respective domain. In another embodiment, the output of the fluid transport device is controlled to govern the overall magnitude of heat transfer. In another embodiment, the fluidic heat transfer media is recovered at or near the surface and is used in one or more external heat exchangers (27) to preheat the reactor input, as shown in FIG. 17.

In another embodiment, the heat exchange media comprises insulative heat transfer media in the protection annulus (717) and/or in one or more heat exchange chambers (716), wherein it restricts heat transfer across its respective domains. Suitable types of insulative heat transfer media include but are not limited to: ceramic foams, fibers, aerogels; polymer/plastic foams, fibers, aerogels; fiberglass; Fiberfrax®, Izoflex®, Rockwool®, perlite; or other materials with a thermal conductivity typically less than 1 W/m K

In another embodiment, the heat exchange media comprises non-electroconductive heat exchange media in the protection annulus and/or in one or more heat exchange chambers (721), wherein it comprises materials that govern the magnitude of heat transfer yet do not conduct electrical energy or otherwise negatively impact the functionality of the energizable components. Suitable forms may comprise solids, porous solids, granular solids, liquids, and gasses.

In one embodiment, non-electroconductive heat exchange media comprises materials that facilitate internal heat transfer. Suitable examples in the solid state generally have a thermal conductivity greater than 1 W/m K and include but are not limited to: sintered ceramics, solid ceramics, ceramic powders, solid glass, glass powders, beryllium oxide, beryllia, aluminum oxide, zirconia oxide, magnesium oxide, low porosity bricks, concrete, cement, earth, rock, granite, plastics, polymers, silicones, quartzes, graphite, graphene, other carbon based components; other solids that are low porosity, high density and/or fine/granular such that they have facilitate heat transfer while not being electroconductive.

In another embodiment, the non-electroconductive heat exchange media comprises fluidic materials, comprising liquids including but not limited to: deionized/purified water, oils, mineral oils, polyolefins; and/liquids including but not limited to: air, nitrogen, argon, sulfur hexafluoride, and/or other fluids that are non-electroconductive. In this embodiment, heat transfer flow is generated by buoyancy induced natural convection and/or fluid transfer devices, and at least in part governs the internal heat transfer.

In another embodiment, non-electroconductive heat exchange media comprises materials that restricts heat transfer. Suitable examples include but are not limited to: ceramic foams, fibers, aerogels; polymer/plastic foams, fibers, aerogels; fiberglass; Fiberfrax®, Izoflex®, Rockwool®, perlite, other low-density solids, other high porosity solids, and/or other materials with insulative properties. In another embodiment, the auxiliary heat transfer media comprises refrigerants, including but not limited to: Chlorofluorocarbons such as R12, Hydrochlorofluorocarbons, such as R22, and Hydrofluorocarbons such as R134 and R410, or other materials that can absorb heat under the ranges of temperatures and/or pressures within their respective domains.

### The Heat Exchange Zone

The HEZ governs the magnitude of internal heat transfer in the upper regions of the wellbore reactor and provides temperature and pressure increases in an energy efficient, gradual, and controlled manner. Furthermore, the HEZ cools the up-flowing output while maintaining a suitable temperature/pressure profile therein. The HEZ can be configured to govern the cumulative and/or localized internal heat transfer to modify reaction and/or reactor dynamics including but not limited to: increase energy efficiency of the wellbore reactor, adjust reactor output temperature, adjust input temperature to SFHZ, adjust heating rate of input with respect to localized pressures, adjust cooling rate of output with respect to localized pressures, adjust residence time of conditions facilitating targeted and/or transformation reactions without localized skin frequency heat transfer.

For embodiments comprising a wellbore reactor with heat exchange annulus, the magnitude of internal heat transfer is, at least in part, governed by the location, quantity, and the dynamics of the heat exchange media within the individual heat exchange chamber(s) (70). FIG. 5 shows an embodiment outlining the direction and relative magnitude of the internal heat transfer (751) through three heat exchange chambers, wherein heat is transferred from the hot up flowing output in the inner channel, to the inner piping, wherein heat is transferred to one or more heat exchange chamber(s), comprising non-electroconductive heat exchange media, wherein heat is transferred to the middle piping wall, wherein heat is transferred to the cool downflowing input in the outer channel (265). In another embodiment, the reactor output is in the outer channel, where in the internal heat transfer reverses direction and goes from the outer channel to the inner channel (752). In one embodiment, conductive heat transfer media (706) and or pipe modifications on the inner pipe (691) and/or middle pipe (694) are used to increase internal Heat transfer (753) and insulative heat transfer media (716) is used to restrict internal heat transfer (754).

For embodiments comprising a wellbore reactor with direct heat exchange, internal heat exchange between the inner and outer channels is direct inner pipe as shown by FIGS. 8-10. The magnitude of internal heat transfer is, at least in part, governed by the configuration of the internal pipe and optionally the central conductor. In one embodiment piping modifications on the inner surface of the inner pipe (691) and/or on the outer surface of the outer pipe (692) increase the magnitude of internal heat transfer (753). In another embodiment, nonmagnetic cladding reduces the magnitude of internal heat transfer. In another embodiment, electro-insulators on the inner surface of the inner piping and/or on the outer surface of the inner piping (479) comprise thermally insulating materials and further restrict the magnitude of internal heat transfer. In general, the cladding can be described as reactive cladding that may put catalytic materials in contact with the feed mixture as it flows past the cladding that is affixed to the surface of the piping or the central conductor.

In another embodiment, nonmagnetic energizable components within the HEZ accepts energy at selected frequency(s) at or near the surface wherein it conducted down to the SFHZ without generating appreciable heat. Suitable nonmagnetic energizable components comprise one or more segments of pipes, tubing, casing, channels, and/or other types of components that provide an axial boundary to fluid flow, and comprise materials including but not limited to: aluminum, copper, or other nonmagnetic low electrical resistance material that do not generate appreciable heat under the selected frequency(s). In another embodiment, the nonmagnetic energizable components comprises a nonmagnetic cladding, liner, coatings and/or other forms of depositing a nonmagnetic domain on one or more surfaces of the energizable components. In another embodiment the nonmagnetic cladding is on the outer surface of the coaxially smaller nonmagnetic energizable component, and on the inner surface of the coaxially larger nonmagnetic energizable component, which comprise ferromagnetic materials. In another embodiment, the nonmagnetic cladding is between 1% and 50% of the respective wall thickness of the energizable component, or 2-40%, or 5-33% or 10-25%.

### Skin Frequency Heater Zone

The Skin Frequency Heater Zone (SFHZ) accepts the electrical energy, optionally conducted from the nonmagnetic energized components, which could be emplaced as inner (435) middle (440) or outer (445) pipe, and generates skin frequency heat transfer from the ferromagnetic energizable components wherein the temperature is established and maintained within the desired ranges to facilitate transformation reactions with temperatures between 20-760° C.

Standard ferromagnetic components do not typically have sufficient electrical resistance to generate appreciable heat from electrical energy. However, if the electrical energy is at suitable frequencies, the ferromagnetic energizable components can generate the following types of internal heating: skin effect, eddy current, Joule heating, and hysteresis losses, wherein they deliver skin frequency heat transfer to the inner channel (771) and/or to the outer channel (772). Suitable ferromagnetic energizable components comprise one or more segments of pipes, tubing, casing, channels, and/or other types of components that provide an axial boundary to fluid flow, and comprise materials including but not limited to: steel, stainless steel, 300 series stainless steel, 400 series stainless steel, Inconel’s, other alloys, high alloys, and/or other materials that generate skin frequency heating from the selected frequencies of the frequency generator.

The cumulative and/or localized magnitude of skin frequency heat transfer depends on any combination of the frequency electrical energy and the magnitude of the electric current from the frequency generator, the ratio of coaxial diameters of the energizable components, and the material properties of the ferromagnetic components such as the resistivity and magnetic permittivity thereof (see US 8,408,294 and 8,210,256). Suitable frequency ranges of the electric energy output from the frequency generator are between 50-5,000 ,000 Hz, or between 100-500,000 Hz, or between 500-250,000 Hz, or between 1000-100,000 Hz, or between 2,000-50,000 Hz, or between 3,000-30,000 Hz.

The temperature profile of the inner and outer channels within the SFHZ are tailored to the meet the diverse transformation reactions by, at least in part, configuring components that control the cumulative magnitude of the skin frequency heat transfer by variables including but not limited to:
the total output and configuration of the frequency generator,
the configuration of the ferromagnetic energizable components that would determine its maximum heating potential, such as the materials composition thereof,
the cumulative lengths, the respective diameters of the energizable components and/or whether skin effect heat transfer is continuous or discontinuous throughout the SFHZ
The magnitude and direction of supplemental internal heat transfer in the SFHZ

In addition to achieving the temperature, the cumulation of hydrostatic pressure and/or the use of one or more downhole pressure control devices are utilized to achieve the transformation pressure, within the SFHZ. Once the desired transformation reaction conditions are achieved, they are maintained within the desired ranges in the SFHZ, or in some embodiments, the SFHZ and regions of the HEZ, at least in part, for a residence time suitable to transform the feedstock to the desired recoverable product.

In one embodiment, as shown in FIG. 11, a transformation temperature is achieved and maintained via a wellbore reactor with continuous skin frequency heat transfer of the same ferromagnetic energizable component followed by continuous nonmagnetic energizable components. In another embodiment, as shown in FIG. 1, desired temperature ranges are maintained in a non-continuous and/or cyclical manner, wherein the temperature in the upflowing inner channel reaches an upper limit, after which one or more subsequent nonmagnetic energized inner pipes eliminates the skin frequency heat transfer until the temperature drops to a lower limit, wherein one or more ferromagnetic energized inner pipe subsequently resumes skin frequency heat transfer. In another embodiment, after the desired temperature is achieved, the ferromagnetic energizable components switches to a different ferromagnetic material with a lower maximum heating potential, thus reducing the magnitude of skin frequency heat transfer to a level that continuously maintains the transformation temperature. In another embodiment, all of the energizable components comprise ferromagnetic materials, wherein skin frequency heat transfer is delivered to the inner and outer channel of the entire wellbore reactor.

### Heat Exchange Chamber

For embodiments comprising a wellbore reactor with a heat exchange annulus, the heat exchange annulus comprises one or more heat exchange chambers as defined herein: one or more sealed domains in the heat exchange annulus comprising heat exchange media, wherein its domain governs the magnitude of internal heat transfer between the inner and outer channels. Heat exchange chamber(s) are bound by any two items of the following: one or two sealing centralizers (506); the solid circuit return; and wellhead (16).

In one embodiment, the uppermost portion of the heat exchange chamber is bounded by the wellhead, and the lowermost portion is bounded by the circuit return. In another embodiment, as shown in FIG. 6, one or more heat exchange chambers comprise one or more pass through centralizers, wherein they are affixed to the outer surface of the inner pipe and, at least in part, extend outward into the heat exchange chamber (517); are affixed to the inner surface of the middle pipe, and at least in part extend inward into the heat exchange chamber (518); and/or they are affixed to the inner and middle pipe and comprise the entire cross section of the heat exchange chamber (516), to ensure there is no conduction of electrical energy due to the proximity of the inner and middle piping. In another embodiment, at least one non-electroconductive sealing centralizers (506) is utilized to define the location, volume, and quantity of individual heat exchange chamber(s), as shown in FIG. 5. In another embodiment, wherein there are at least 2 heat exchange chamber(s), the heat exchange chambers have different total lengths.

In one embodiment, at least one heat exchange chamber comprises conductive heat transfer media (706) or fluidic heat transfer media (711) comprising heat transfer flow (676, 677, 679), wherein the chambers are, at least in part, in the HEZ, and facilitate a high magnitude of internal heat transfer (753), wherein the rate of temperature gain of the downflowing input increases and/or rate of temperature loss of the upflowing output decreases. In another embodiment, insulative heat transfer media (716) are in one or more heat exchange chambers in regions representative of the transition between the HEZ and SFHZ, wherein the magnitude of internal heat transfer is restricted (754), thereby decreasing the rate of temperature loss, wherein the regions that comprise the temperature representative of one or more transformation reactions extend upward into the HEZ. In another embodiment, at least one heat exchange chamber is located in the SFHZ, and comprises heat transfer media that facilitates internal heat transfer between the inner and outer channel (706, 711), wherein the magnitude of skin frequency is supplemented and/or harmonized between the channels.

### Protection Annulus

A protection annulus is bounded by the outer surface of the outer pipe and one or more components of the protection string and governs the magnitude and direction of external heat transfer by configuring the heat transformation media and/or dimensions within. In one embodiment, the entire protection annulus comprises the same heat transfer media. In another embodiment, the protection annulus comprises two or more protection annulus chambers with different heat transfer media. In another embodiment, a sealing centralizer (507) is used segregate the protection annulus chambers, with respect to the total length of the wellbore reactor. In another embodiment, the protection string comprises 2 or more components that have smaller diameter (508) and larger diameter (509) and are used segregate the protection annulus chambers, with respect to the radial dimension. In another embodiment, wherein the outer piping comprises an energizable component, the protection annulus comprises heat transfer media and/or electro insulators that do not interfere with the function and/or dynamics of the energizable components.

In one embodiment, the protection annulus, at least in part, comprises fluidic heat transfer media, that facilitates external heat transfer to and from the outer channel (767), wherein heat transfer flow is generated by the discharge of a pump or other fluid transfer device. In one embodiment, wherein the downflowing input is in the outer channel, the fluidic heat transfer media further increases temperature thereof. In another embodiment, wherein the upflowing output is in the outer channel, the fluidic heat transfer media further cools the output, and can be optionally used to in one or more external heat exchangers to increase the temperature of the feed mixture.

In one embodiment, wherein the subsurface formation has generally lower temperatures than the wellbore reactor, the protection annulus comprises insulative heat transfer media (117) that restrict external heat transfer (766) to the subsurface formation (761). In another embodiment, the diameter of the protection annulus is increased to further restrict external heat transfer to the subsurface formation.

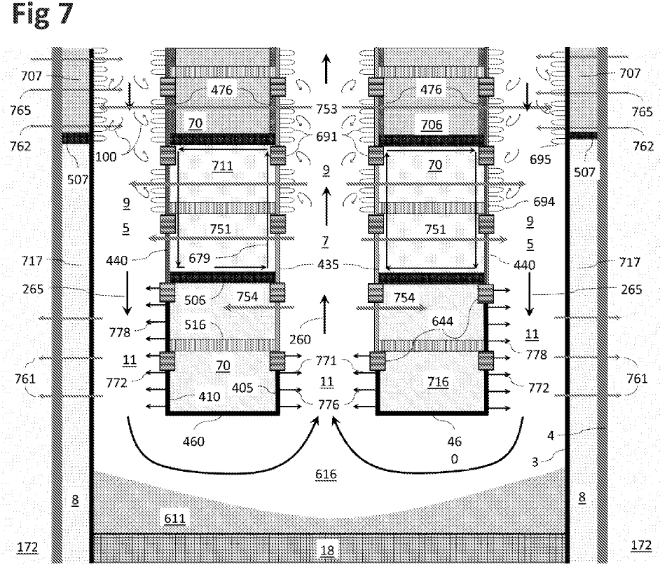

In one embodiment, wherein a geothermal gradient creates a subsurface formation with a higher temperature than at least a region of the wellbore reactor (172), the protection annulus, at least in part comprises conductive heat transfer media (707) to facilitate a positive external heat transfer into the outer channel (762) from the regions comprising the desirable geothermal temperatures, as shown in FIG. 7. In another embodiment, the protection annulus and protection string is eliminated from the wellbore reactor system, giving direct heat transfer between the outer piping and the subsurface formation thus increasing the external heat transfer.

In one embodiment, the protection annulus locates optional components including but not limited to: reactor sensors (621) & connections thereof (622) to monitor conditions such as temperature, pressure, flow sensors in the outer channel; and/or one or more reactor tubing.

### Modification of Fluid Dynamics

In some embodiments, optional modifications to the configuration of the wellbore piping are made to control the fluid dynamics, and subsequently the thermal dynamics thereof. Different techniques including but not limited to: downhole pressure control devices (550), piping modifications, depth varied piping diameters (84), can be used in conjunction with each other to, at least in part, achieve the desired thermofluidic dynamics.

### Piping Modifications

The wellbore reactor may comprise one or more optional piping modifications (FIGS. 5 - 10) as defined herein: physical features or other types of additions and/or modifications to the reactor piping to increase flow agitation, internal heat transfer performance, and/or provide additional surface area contact to the fluid in communication therein. Piping modifications on one or more surfaces of the reactor piping are suitable to improve reaction mechanisms and/or reactor dynamics provided they do not negatively impact the dynamics or performance of the energizable components. Furthermore, piping modifications can be used in conjunction with at least one of downhole pressure control devices, and/or depth varied piping diameters, to further modify the thermofluidic dynamics.

In one embodiment, piping modifications comprise features including but not limited to: ribbing, baffles, turbulators, fins, and/or pipe couplers, such that they increase the surface area and/or induce/increase flow agitation. In another embodiment, piping modifications comprise the planned corrosion of the piping, piping modifications and/or other components, to induce positive side effects such as: increased roughness, resulting in increased surface area and flow agitation, and/or contribute functional metals representative of reaction agents.

In one embodiment, piping modifications are on one or more piping surfaces comprising the inner surface of the inner pipe (691), the outer surface of the inner pipe (692), the outer surface of the middle pipe (694), the inner surface of the outer pipe (695) and/or the outer surface of the central conductor (697). In another embodiment, piping modifications are on one or more surfaces of the energized components wherein they do not interfere with the conduction of the electrical energy at selected frequencies and/or the generation of skin frequency heat transfer (770).

In one embodiment, piping modifications are on one or more surfaces of the reactor piping within the HEZ (531, 532, 533), wherein they increase surface area and/or induce/increase the flow agitation (100), wherein this increases the magnitude of internal heat transfer. In another embodiment, piping modifications are on one or more surfaces of the reactor piping in the SFHZ, wherein they increase surface area and/or induce/increase flow agitation, thus increasing the magnitude of skin frequency heat transfer (773) as shown in FIG. 9. In another embodiment, piping modifications are on the inner surface of the outer piping (695), wherein they increase surface area and/or induce/increase flow agitation, thus increasing the magnitude of external heat transfer.

In one embodiment, piping modifications are on one or more surfaces of the reactor piping, and comprise functional metals such as iron, copper, and/or nickel that function as a reaction agent (698), wherein the increased flow agitation, and/or increase in surface area improve the performance and/or function of the reaction agents.

### Downhole Pressure Control Devices

The wellbore reactor may comprise one or more optional downhole pressure control devices (660 - 667) as defined herein: device(s) that control the fluid dynamics within the inner and/or outer channel to change the pressure and/or fluid velocity prior to and/or subsequent of the feature. Downhole pressure control devices can increase and/or decrease the pressure independently from temperature within the wellbore reactor, and are suitable for avoiding undesirable pressure sensitive reactions, facilitating desirable pressure sensitive reactions, and/or controlling the pressure in the upper regions, prior to the wellbore reactor. Suitable downhole pressure control devices comprise flow control devices common in the art, including but not limited to: choke valves, check valves, choke orifices, throttling orifices, Tesla valvular conduit and/or equivalents, subsurface safety valves or similar functionality devices.

In one embodiment, as shown in FIG. 14A, the wellbore reactor comprises one or more downhole pressure control devices, affixed to one or more surfaces of the reactor piping in a staggered configuration, extending inward (551) and/or outward (552), wherein changes of flow direction, and/or the generation of pressure vortices (554) achieves the desired changes in the pressure profile. In another embodiment, the wellbore reactor comprises one or more downhole pressure control devices, affixed to one or more surfaces of the reactor piping, that symmetrically extend towards each other to temporarily reduce the area within the inner and/or outer channel (553), wherein the resulting choke achieves the desired changes in the pressure profile.

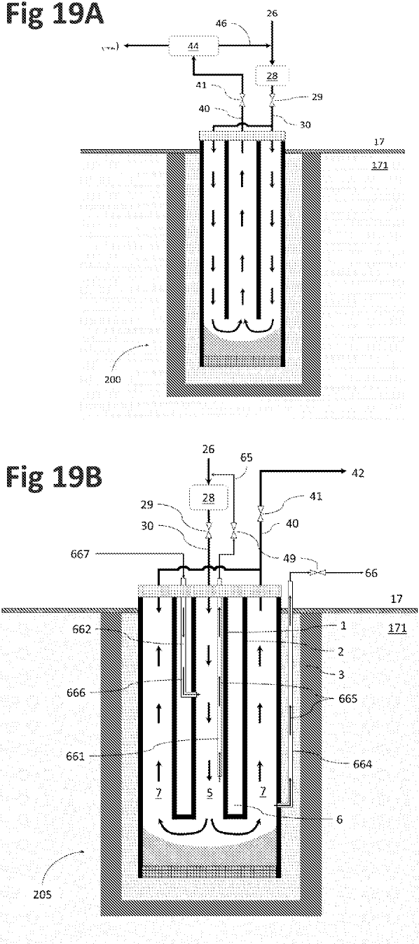

In one embodiment, the wellbore reactor comprises one or more reactor tubes in the inner channel (661), heat exchange annulus (662), outer channel (663), and/or protection annulus (644) wherein the addition or removal of fluid from locations within the wellbore reactor controls the subsequent pressure profile, as shown in FIG. 19B.

In one embodiment, a fluid comprising at least one diluent, activator, reaction agent and/or an inert liquid/gas, is pressurized at the surface (667), flows down one or more pressure control tubes, wherein it is discharged into the inner and/or outer channels (666), to increase the pressure in a supplementary manner. In another embodiment, one or more pressure control tubes are connected to a pressure relief control device (49), wherein sufficient fluid is removed from the wellbore reactor (665), to prevent an undesired increase in pressure and/or decrease the pressure, wherein the pressure relief material is recycled to any series of feedstock preparation and pre-feed operations (65) or is sent to any one of the reactor output, product separation and recovery operations (66) for recovery as a recoverable product and/or treated as dross. In another embodiment, the excess pressure can be mitigated by pressure relief systems know in the art, similar in function to a rupture disc, wherein excess pressure is released into the volume of the heat exchange annulus and/or protection annulus.

### Depth Varied Piping Diameters

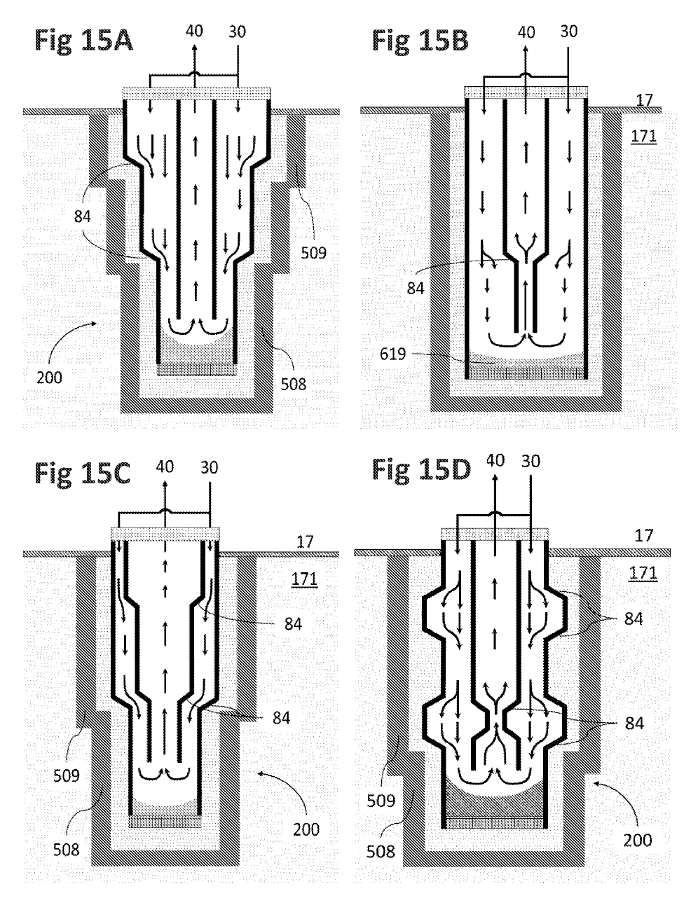

The wellbore reactor may comprise one or more segments of reactor piping, wherein the diameter changes at one or more reactor lengths, to change the localized pressure and/or velocity in the inner and/or outer channel. As shown in FIG. 15, this is achieved by one or more tapered segments, at one or more locations within the wellbore reactor, wherein they expand or reduce the diameter of the inner piping, middle piping, outer piping and/or protection strings.

In one embodiment, the diameters of all reactor piping change at the same location wherein the cross section of the inner and outer channel change in the same manner. In another embodiment, the diameters of the reactor piping change in a manner that the cross section of the inner and/or outer channel change in an independent manner. In another embodiment, the diameter of one reactor piping changes, while the other reactor piping remains constant.

In one embodiment, one or more tapers increase the cross-sectional area of the downflowing input channel near the surface and could be used to mitigate the challenges associated with pumping and/or pressurizing the feed mixture into the wellbore reactor, as shown in FIG. 15A. In another embodiment, one or more tapers increases the cross-sectional area of the upflowing output channel near the surface and could be used to reduce the temperature and/or pressure of the reactor output, as shown in FIG. 15C. In another embodiment, one or more tapers increase the cross-sectional area of the inner and/or outer channel at one or more intermediate depths and could be used to increase the residence time of desired targeted and/or transformation reactions, reduce localized pressure and/or adjust the heat transfer dynamics, as shown in FIG. 15D. In another embodiment, one or more tapers decrease the cross-sectional area of the inner and/or outer channel at one or more intermediate reactor lengths and could be used to decrease the residence time of undesirable reactions, increase localized pressure and/or adjust the heat transfer dynamics. In another embodiment, one or more tapers increase the cross-sectional area of the inner and/or outer channel at or near total vertical depth and could be used to increase the residence time of the transformation reactions and/or achieve complete heating from the ferromagnetic energized components. In another embodiment, one or more tapers decrease the cross-sectional area of the inner and/or outer channel at or near total vertical depth and could be used to decrease the residence time of undesirable reactions, adjust the heat transfer dynamics, and or increase the upflowing velocity in a way that minimizes the accumulation of precipitate in the dropout chamber (619), as shown in FIG. 15B.

### Feedstock Preparation and Pre-Feed Operations

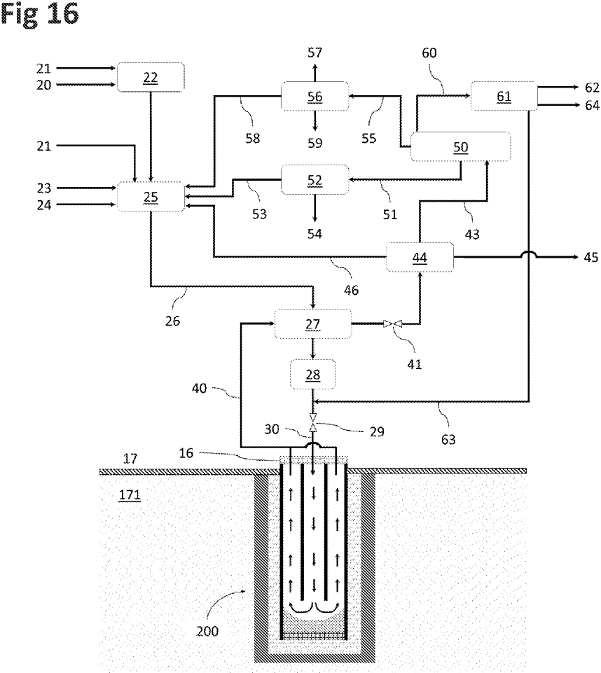

The feedstock is converted into a pumpable fluid or slurry in a series of operations common in the art for forming and transferring mixtures comprising solids and/or viscous materials. FIG. 16, FIG. 17, and the disclosures therein present one viable option to create a reactor input, comprising at least one of these operation options, present in any order:
One or more mills that reduce the particle size of one or more feedstock inputs
Formation of approximately homogenously sized pumpablefeed mixture comprising the feedstock, diluent(s), reaction agent, activator and/or input recycle streams
One or more external heat exchangers and/or external heaters to preheat the feed mixture
One or more injection pumps to generate reactor input pressure and flow rate
Input control device(s) to control flow rate, residence times and/or reactor pressures in conjunction with output control device(s)

### Feed Mixture Creation

A feed mixture (26) is a pumpable fluid that comprises feedstock(s) (20), direct input(s) and/or recycle input(s) to the wellbore reactor. In one embodiment, a suitable diluent level is inherent to the feedstock. In another embodiment, the diluent(s) (21), activator (24) and/or reaction agent (23) are added as a direct input at one or more feedstock preparation and pre-feed operations. In another embodiment, the diluent(s) (58), activator (58) and/or reaction agent (53) are, at least in part, added from one or more respective recycle streams at one or more feedstock preparation and pre-feed operations.

In one embodiment, wherein the feedstock comprises bulk solid material, has high solids content; has high lignin content; density and/or hard molecular structures; and/or inconsistent particle sizes, one or more milling (22) steps are utilized. Milling techniques that reduce and/or homogenize particle sizes are common in the art including but not limited to: high shear mixers, ball mills, bead mills, attritor mills, horizontal mills, hammer mills, rod mills, grinders, cutters, shredders, or macerators. Some milling techniques may be suitable for solid state conditions, whereas others may be suitable for liquid state conditions, and in some embodiments, at least a part of the diluent, is added. In another embodiment, wherein the feedstock is already in a liquid, fluids and/or solids suspension, one or more feed mixers (25), such as a tank with a mixer/agitator, provide sufficient energy to create a pumpable fluid, eliminating the dedicated milling step.

### Pre-Heating

In one embodiment, the feed mixture is transferred to the injection pump and is input to the reactor, wherein the heating is from the work of the process equipment. In another embodiment, one or more external pre-heating steps are utilized at one or more feedstock preparation and pre-feed operations streams, to achieve a reactor input temperature between 25-350° C., or 40-300° C., or 50-250° C., or 60-200° C., or 75-150° C., or 30-100° C., or 40-90° C., or 50-80° C., or 30-75° C., or 150-300° C. or 150-250° C. or 200-350° C. or 75-300° C. or 75-250° C., or 75-200° C.

In one embodiment, the feed mixture is preheated with one or more external heat steps prior to the injection pump. In another embodiment, one or more external heat steps are located after the injection pump. In another embodiment, more than one external heat steps are located prior to, in between and/or after any combination of feedstock preparation and pre-feed operations. In another embodiment, to avoid fouling of the external heat exchanger(s), the diluent(s), activator(s) and/or any recycled inputs are preheated separately.

In one embodiment, one or more external heat steps comprise one or more external heat exchangers (27), at one or more feedstock preparation and pre-feed streams by cooling one or more reactor output, product separation and recovery streams, and/or the output of one or more heat transfer tubes. In another embodiment, one or more external heat exchangers utilize the process cooling fluid (34), that cool one or more pieces of heat generating surface equipment.

In another embodiment, one or more an external heaters (36) provide direct heat to any series of feedstock preparation and pre-feed streams. In one embodiment, the external heater(s) provide heat from electrical sources. In another embodiment, the external heater(s) provide heat from combustible fuels including but not limited to: hydrogen, methane, ethane, ethylene, propane, propylene, butane, isobutane, butylene pentane, gasoline, diesel, alcohols, solvents, or other hydrocarbon components that generate suitable combustion heat. In another embodiment, wherein the external heater(s) provide heat from combustible gasses, the combustible gasses are, at least in part, recovered from the gas phase (60). In another embodiment, wherein the external heater(s) provide heat from combustible liquids, the combustible liquids are, at least in part, recovered from the liquid phase (55).

### Injection Pumping

One or more feed mixture streams is transferred to one or more injection pumps (28), wherein they provide sufficient flow and discharge pressures to establish the desired ranges for the transformation reactions, when combined with the hydrostatic pressure. Suitable injection pumps are common in the art of chemical processing such as duplex, triplex and quintuplex pumps, or gas compressors, wherein they are capable of operationally delivering up to 700 bar, or 10-500 bar, or 50-250 bar, or 100-200 bar, or 75-175 bar, or 100-150 bar, or 10-100 bar, or 25-75 bar, or 100-500 bar, or 150-400 bar, or 200-300 bar, at desired flowrates of the reactor input. In one embodiment, a singular injection pump is used. In another embodiment more than one injection pump is configured in series, parallel or any combination thereof.

### Electrical Power

In one embodiment, the electrical power is, at least in part, accepted from an offsite electrical grid. In another embodiment, the electrical power is, at least in part, generated onsite (37). In another embodiment, the onsite electricity generator utilizes suitable hydrocarbon fuels that, at least in part, are recovered from the liquid (55) and/or gas phases (60) to produce electricity (35) for one or more processes. In another embodiment, the onsite electricity generator is cooled by a process coolant, which is subsequently utilized the external heat exchanger(s).

In one embodiment, the onsite electricity generator utilizes an internal combustion engine that consumes liquid hydrocarbon fuels, including but not limited to: diesel, gasoline, and/or fuel oils or gas hydrocarbon fuels including but not limited to: methane, ethane, propane, and/or butane. In another embodiment, the onsite electricity generator utilizes a gas turbine system that consumes hydrocarbon fuels including but not limited to: methane, ethane, propane, and/or butane.

### Reactor Input

One or more pressurized feed mixtures flow through one or more input control devices (29), comprising techniques known in the art to control fluid pressure and/or flow, including but not limited to: valves, downhole pressure control devices, depth varied piping diameters, and/or external heat exchangers (27), form one or more reactor inputs (30). In one embodiment, the input control device(s), in conjunction with one or more output control devices, downhole pressure control devices, and/or depth varied piping diameters (84) are used to control the flow rates, residence time and system pressure. In one embodiment, reactor pressure can be increased by configuring the input control device to a less restrictive state and configuring the output control device to a more restrictive state, until desired conditions are reached. In another embodiment, high flow rates and/or reduced reactor residence times can be achieved by configuring both the input and output pressure control devices to a less restrictive state until desired conditions are reached. In another embodiment, lower reactor pressures can be achieved by configuring the input control device to a more restrictive state and configuring the output control device to a less restrictive state, until desired conditions are reached.

### Reactions and Operations

The Universal Wellbore Reactor System is designed to provide a high level of flexibility, and as such there are numerous configurations that can be tailored to the different classifications, types and grades of feedstocks and recoverable products. Furthermore, the wellbore reactor can be tailored to reduce capital/installation cost, and operation cost. As such suitable configurations described in this disclosure include but are not limited to, varying the reactor depth and reactor piping diameters; configuring the quantity, location, and materials of the energized components; the presence and configurations of heat exchange chamber(s) therein; the cumulative magnitude of internal heat transfer; the cumulative magnitude and direction of external heat transfer; the ability to utilize residual heat from heat transfer media in external heat exchangers; the independent control of pressure by downhole pressure devices, depth varied piping, and laterals. Any of which are used in conjunction to modify the thermofluidic dynamics, resulting a wide range of temperature and/or pressure profiles that facilitate the transformation of desired feedstocks to desired recoverable products.

### Near Ambient Transformation

In one embodiment, the universal wellbore reactor system facilitates near ambient transformation (NAT) from one or more feedstocks wherein the transformation reactions occur in a narrow range at relatively low temperatures and pressures. In one embodiment, one or more wellbore reactors are configured to enable NAT in temperature ranges between 20-90° C. or between 40-80° C., or between 50-70° C.

In one embodiment, the feedstock comprises hydrocarbon waste, and one or more wellbore reactors are configured to enable NAT to produce renewable hydrocarbon products via thermophilic digestion, mesophilic digestion, fermentation and/or other forms of biotic processes, as defined by generating recoverable products from biota such as bacteria, yeast, algae and other productive microorganisms. In another embodiment, the feedstock comprises animal manures and/or sewage sludge, and the diluent comprises water, which is at least in part, inherent to the feedstock. In another embodiment, biotic micro-organisms are naturally present in the feedstock.

In one embodiment, one or more wellbore reactors are configured to enable NAT to produce renewable hydrocarbon products comprising combustible hydrocarbon gases such as methane, ethane, or propane; hydrogen gas or any other combustible organic gas; carbon dioxide; or organic and/or inorganic gasses of value. In another NAT embodiment, one or more wellbore reactors are configured to enable NAT to renewable hydrocarbon products comprising liquid hydrocarbon products comprising ethanol or methanol.

In one NAT embodiment, biotic micro-organisms are added to facilitate desired targeted and/or transformation reactions. In another NAT embodiment, wherein biotic micro-organisms are naturally present in the feedstock, supplementary biotic micro-organisms of the same classification are added. In another NAT embodiment, supplementary biotic micro-organisms of different classifications than those naturally present in feedstock are used, at least in part, to favor the production of different types of gas phase recoverable products, such as hydrogen.

In one NAT embodiment, the pressure profile from the reactor input to the transformation pressure, to the reactor output, is such that it does not compromise the viability of the biotic organism. In another NAT embodiment, the transformation pressure is at the maximum reactor length and is less than 200 bar, or less than 100 bar, or less than 50 bar, or less than 20 bar. In another NAT embodiment, wherein the biotic organism is pressure sensitive, one or more laterals increase reactor volume, while reducing the relative rate of pressure change and/or total pressure from hydrostatic forces. In another NAT embodiment, wherein the biotic organism is pressure sensitive, one or more downhole pressure control devices and/or tapers (84) are used to avoid damaging pressure conditions.

In one NAT embodiment, comprising temperature sensitive biotic organisms, the ferromagnetic energizable components are configured in a way that the skin frequency heat transfer does not provide excessive heat. In another NAT embodiment, the temperature on the surface of the ferromagnetic energized components is less than 120° C. or less than 100° C. or less than 80°

In another embodiment, reactor sensors are located in the inner and/or outer channels and are configured to monitor the pressure and temperatures to keep them in ranges below harmful values for the biota.

In another embodiment, the wellbore reactor is located in an area wherein the geothermal conditions deliver energy to the system in a way that reduces the energy input from the frequency generator. In another embodiment, the geothermal conditions deliver sufficient external heat transfer to maintain the transformation reactions, thereby eliminating the energy input from the frequency generator and skin frequency heat transfer.

In some NAT embodiments, one or more wellbore reactors utilize shallow wellbores with large diameters. In one NAT embodiment, the wellbore reactor volume is increased by selecting a relatively large diameters of reactor piping, wherein the inner surface of the outer piping is between around 132-24 inches inner diameter, or 120-36″, or 96-48″ or 8-68″, or 10-56″, or 12-44″, or 14-32″. In another NAT embodiment, one or more subsequent wellbore reactors, configured for NAT, cumulatively increase the total reactor volume.

### Hyperthermal Transformation

In one embodiment, the universal wellbore reactor system facilitates Hyperthermal Transformation (HTT), wherein the transformation to recoverable products occurs at temperature(s) and/or pressure(s) that are below the critical point of the diluent(s). In another embodiment, one or more wellbore reactors are configured to enable HTT in ranges between 70-500° C. and 25-500 bar; or 150-400° C. and 50-500 bar; or 250-400° C. and 150-500 bar. In another embodiment, wherein the diluent comprises water, one or more wellbore reactors are configured to enable HTT in ranges between 175-372° C. and 50-500 bar; or 250-372° C. and 75-500 bar; or 300-372° C. and 100-500 bar; or 325-372° C. and 150-500 bar.

In one embodiment, the feedstock comprises hydrocarbon waste and one or more wellbore reactors are configured to enable HTT to recoverable products comprising renewable hydrocarbon products. In another embodiment, the feedstock comprises one or more groups of: agricultural waste, forest residues, and/or treated wastewater, and one or more wellbore reactors are configured to enable HTT to renewable hydrocarbon products comprising one or more groups of: substitutes for crude oils, substitutes for final fuels and/or, components of petroleum products. In another embodiment, the feedstock comprises animal manures and/or the output from wastewater treatment plants and the diluent comprises water that is, at least in part, inherent to the feedstock.

In one embodiment, the feedstock comprises metallic entrained waste and/or mineral rich resources and one or more wellbore reactors are configured to enable HTT to one or more recoverable products, comprising advanced materials, and/or suitable precursors thereof. In another embodiment, the feedstock comprises mine tailings, and one or more wellbore reactors are configured to enable HTT to recoverable products comprising REE, critical materials, and/or precious metals. In another embodiment, the feedstock comprises metallic entrained waste comprising municipal solid waste, and one or more wellbore reactors are configured to enable HTT to recoverable products comprising REE, critical materials, and/or precious metals. In another embodiment, the feedstock comprises metallic entrained industrial waste, and one or more wellbore reactors are configured to enable HTT to recoverable products comprising REE, critical materials, and/or precious metals. In another embodiment, the feedstock comprises mineral rich resources comprising the output from the mining operations of critical materials and/or precious metals, and one or more wellbore reactors are configured to enable HTT to recoverable products comprising critical materials and/or precious metals thereof. In another embodiment, the feedstock comprises metallic entrained waste and hydrocarbon waste, and one or more wellbore reactors are configured to enable HTT to recoverable products comprising renewable hydrocarbon products and advanced materials. In another embodiment, the feedstock comprises combustion byproducts and one or more wellbore reactors are configured to enable HTT to recoverable products comprising renewable hydrocarbon products and advanced materials.

### Super Critical Diluent Transformation (SCDT)

In one embodiment, the universal wellbore reactor system facilitates Super Critical Diluent Transformation (SCDT), wherein the transformation to recoverable products occurs at temperatures and pressures, above the critical point of the diluent(s). In another embodiment, one or more wellbore reactors are configured to enable SCDT in ranges between 250-600° C. and 50-600 bar; or 350-600° C. and 100-600 bar. In another embodiment, wherein the diluent comprises water, one or more wellbore reactors are configured to enable SCDT in ranges between 373-600° C. and 220-600 bar; or 400-600° C. and 300-600 bar. Due to the gradual changes in temperature and pressure, SCDT embodiments will comprise HTT conditions prior to achieving SCDT and/or after completing SCDT, wherein one or more targeted and/or transformation reactions may occur thereof.

In one embodiment, the feedstock comprises hydrocarbon waste, and one or more wellbore reactors are configured to enable SCDT to recoverable products comprising renewable hydrocarbon products. In another embodiment, the feedstock comprises one or more groups of: agricultural waste, forest residues, and/or outputs from wastewater treatment plants, and/or hydrocarbon rich industrial wastes, and one or more wellbore reactors are configured to enable SCDT to recoverable products comprising renewable hydrocarbon products comprising one or more groups of: substitutes for crude oils, substitutes for final fuels and/or, components of petroleum products. In another embodiment, the feedstock comprises animal manures and/or the output form wastewater treatment plants, and the diluent comprises water that is, at least in part, inherent to the feedstock, and one or more wellbore reactors are configured to enable SCDT to recoverable products comprising renewable hydrocarbon products.

In one embodiment, the feedstock comprises metallic entrained waste and/or mineral rich resources, and one or more wellbore reactors are configured to enable SCDT to one or more recoverable products, comprising advanced materials, and/or suitable precursors thereof. In another embodiment, the feedstock comprises mine tailings, and one or more wellbore reactors are configured to enable SCDT to recoverable products comprising REE, critical materials, and/or precious metals. In another embodiment, the feedstock comprises metallic entrained waste comprising municipal solid waste, and one or more wellbore reactors are configured to enable SCDT to recoverable products comprising REE, critical materials, and/or precious metals. In another embodiment, the feedstock comprises metallic entrained industrial waste, and one or more wellbore reactors are configured to enable SCDT to recoverable products comprising REE, critical materials, and/or precious metals. In another embodiment, the feedstock comprises mineral rich resources comprising the output from the mining operations of critical materials and/or precious metals, and one or more wellbore reactors are configured to enable SCDT to recoverable products comprising critical materials and/or precious metals thereof. In another embodiment, the feedstock comprises metallic entrained waste and hydrocarbon waste, and one or more wellbore reactors are configured to enable SCDT to recoverable products comprising renewable hydrocarbon products and advanced materials. In another embodiment, the feedstock comprises combustion byproducts, and one or more wellbore reactors are configured to enable SCDT to recoverable products comprising renewable hydrocarbon products and advanced materials.

### Subsequent Wellbore Reactors

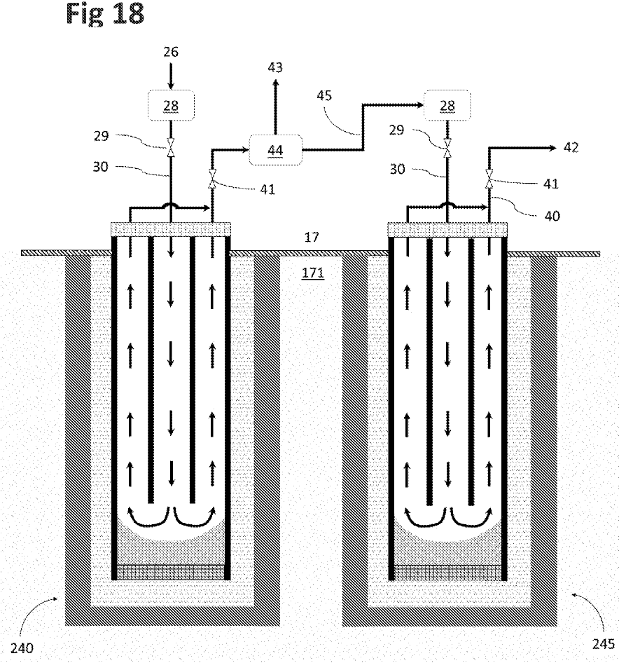

In one embodiment, at least one subsequent wellbore reactor (245) is added to the universal wellbore reactor system, wherein the output of one or more primary wellbore reactors (245) passes through an optional output control device (41), and flows through the reactor connector (45), to an optional additional injection pump (28), passes through an optional input control device (29) wherein the reactor input enters the subsequent wellbore reactor, as shown on FIG. 18.

In one embodiment, one or more subsequent wellbore reactors are configured for the same set of transformation reactions as the primary wellbore reactor, the reactor volume and/or residence time is cumulatively increased. In another embodiment, one or more subsequent wellbore reactors are configured to operate at higher temperature and/or pressure conditions to facilitate targeted reactions and/or transformation reactions of higher conditions thereof.

In another embodiment, one or more wellbore reactors are configured to transform the feedstock to one or more recoverable product(s), which are, at least in part, sent to one or more reactor output, product separation and recovery streams, and the balance of the reactor output is sent to one or more subsequent wellbore reactors, configured to facilitate different targeted reactions and/or transformation reactions, to produce additional recoverable products thereof. In another embodiment, one or more wellbore reactors are configured to transform the feedstock to a recoverable product, wherein at least one deficiency exists, and, the reactor output is, at least in part, sent to one or more subsequent wellbore reactors that are configured to facilitate targeted reactions and/or transformation reactions to improve the quality of the recoverable products.

In one embodiment, at least one subsequent wellbore reactor is configured to facilitate targeted and/or transformation reactions that could not be reached in an optimal way from the one or more prior wellbore reactor(s). In another embodiment, at least one subsequent wellbore reactor is configured to facilitate temperatures and/or pressures that fall outside of the established ranges of NAT, HTT, or SCDT. In another embodiment, at least one subsequent wellbore reactor is configured to facilitate reactions that upgrade the quality of the renewable hydrocarbon product in a way that makes it suitable for use as substitutes of final fuels.

In another embodiment, wherein one or more wellbore reactors are configured to transform a feedstock to a recoverable product(s), the reactor output comprises hazardous and/or undesirable dross byproducts. In one embodiment, subsequent wellbore reactor(s) are configured in a way that facilitates conditions suitable to transform this dross into any one of the following states: neutralized for safe disposal, transformed into a recoverable product, and/or converted into suitable input that can be recycled back to any series of feedstock preparation and pre-feed operations.

### Recirculating Batch Operation

Recirculating batch operations may be used when targeted reactions and/or transformation reactions have long residence time, such as biotic digestion or other NAT embodiments. Optional reaction agent(s) and/or activator(s) can be delivered at one or more reaction batch times to facilitate the desired improvements.

In one embodiment, a singular wellbore reactor is primed and/or pressurized from one or more feedstock preparation and prefeed operations. Once filled, the output selector (44) directs the reactor output back to the reactor input through the input recycle (46), wherein no additional feed mixture is input and the flow and/or pressurization is, at least in part, maintained by the injection pump (28) as shown in FIG. 19A. The recirculation can be continuous or non-continuous provided adequate transformation conditions are achieved. This continues for desired residence time, wherein the output selector directs the reactor output to one or more reactor output, product separation and recovery operations via the product output, wherein fresh feed mixture or suitable displacement media displaces the outgoing reactor volume.

### Semi Batch

Semi batch operations are typically used wherein targeted reactions and/or transformation reactions exhibit partial reactions or would otherwise benefit from more than one pass through the wellbore reactor(s). Furthermore, this configuration facilitates reactor output, product separation and recovery operations which are desirable to operate in a continuous fashion, particularly when it is undesirable to keep adding subsequent wellbore reactors.

In one embodiment, one or more wellbore reactors are filled and pressurized from one or more feedstock preparation and pre-feed operations. Once filled, the output selector directs the reactor output, at least in part, back to any series of feedstock preparation and pre-feed operations. the remainder of the reactor output is sent to one or more reactor output, product separation and recovery operations, and is replaced with an equivalent rate of reactor input, such that properties of the product output are maintained at a desirable and steady state manner.

In another embodiment, one or more wellbore reactors are filled and pressurized from one or more feedstock preparation and pre-feed operations. Once filled, the output selector directs the reactor output back to any series of feedstock preparation and pre-feed operations through the input recycle, wherein no additional feed mixture is input. This occurs until a sufficient amount of residence time passes, wherein the reactor output represents the desired composition. Once achieved, the output selector directs a portion of the reactor output to the product output wherein the equivalent addition of fresh feed mixture is such that properties of the product output is maintained at a desirable and steady state manner.

### Continuous

Continuous operations are typically used wherein targeted reactions and/or transformation reactions have short residence times such that they are sufficiently completed with one pass through the reactor. In one embodiment, the wellbore reactor(s) may utilize recirculating batch and/or semi-batch operations to achieve steady state conditions during any stages of startup before transitioning to continuous operations.

### Reactor Output, Product Separation and Recovery Operations

The reactor output (40) exits the wellbore reactor at or near the surface and goes through a series of recovery and/or separation operations comprising one or more, in any order, including but not limited to:
depressurization through one or more output control devices
Cooling through one or more external heat exchangers, of which the feed mixture is preheated;
One or more output selectors, that directs reactor output to one or more subsequent operations:
   recycled back to the same wellbore reactor via the input recycle
   sent to subsequent wellbore reactors via the reactor connector
   Sent to one or more phase separators, wherein the product output is separated to one or more solid phase(s), liquid phase(s) and/or gas phase(s)

### Depressurization and Recovery

One or more output control devices (41), comprising techniques known in the art to control fluid pressure and/or flow, including but not limited to: valves, downhole pressure control devices, depth varied piping diameters, and/or external heat exchangers are be used in conjunction with the input control devices (29) to control the thermofluidic dynamics, total wellbore reactor residence time, and/or pressure. In one embodiment the output control device comprises one or more depressurization and/or cooling steps, to recover the recoverable product(s). In one embodiment, wherein there is a desirable pressure differential across the input and output of the external heat exchanger, it comprises, at least in part, the output control device.

In one embodiment, the output control device(s) are located and configured in a way that ensures the temperature of the reactor output is sufficiently cool before depressurization, to avoid combustion, oxidation, chemical transformation, and/or other forms of degradation. In another embodiment, the output control device(s) are configured to allow for rapid depressurization, optionally at high temperatures, to facilitate the enhanced recovery of advanced materials.

In one embodiment, the reactor output passes through the one or more output control devices to achieve desired depressurization rates, and optionally, is sent to one or more external exchangers feed mixture. In another embodiment, the reactor output passes through the one or more external heat exchangers to become sufficiently cool and is subsequently depressurized through one or more output control devices. In another embodiment, a series of output control devices are used in conjunction with one or more external heat exchangers for multistep and/or integral cooling and depressurizing.

### Output Selector

One or more output selectors (44) directs the reactor output, to one or more product separation and/or recovery operations. In one embodiment, one or more output selectors sends any portion of the reactor output to one or more phase separators and/or one or more subsequent wellbore reactors via one or more reactor connector streams. In another embodiment, comprising recirculating batch operations, one or more output selectors directs the entire reactor output back into the wellbore reactor via the input recycle to any series of feedstock preparation and prefeed operations, as shown in FIG. 19A. In another embodiment, comprising semi-batch operations, one or more output selectors sends a portion of the of the reactor output back to any series of feedstock preparation and prefeed operations, via the input recycle (46), and the balance flows to any subsequent product separation and/or recovery operation(s).

### Phase Separator

One or more phase separators (50), receive one or more reactor outputs (42, 43) and separate out the solid (51), liquid (55) and gas (60) phases via techniques common in the art including but not limited to: centrifuge, decant, solvent, polymer, and size separation. Optionally, one or more subsequent separators (52, 56, 61), common in the art, are used to further separate, recover, and/or purify individual components from their respective phase outputs (51, 55, 60).

In one embodiment, the liquid/aqueous phase (55) is separated into more than one liquid streams (57, 58, 59) with one or more liquid separators (56). In another embodiment, one or more liquid separators (56) recover the liquid recoverable product(s) (57) from the liquid phase, wherein the balance comprises liquid dross (59) is disposed of. In another embodiment, one or more liquid separators (56) recover the liquid recoverable product(s) (57) from the liquid phase (55), wherein the balance comprises liquid dross (59) and is recycled back and/or sent to one or more subsequent wellbore reactors for further processing. In another embodiment, one or more liquid separators (56); recover fluids components, such as: diluent(s), activator(s), and/or other desirable liquid compounds, and recycle them back to any series of feedstock preparation and prefeed operations (58).

In one embodiment, the gas phase (60) is separated into more than one gaseous streams (62, 63, 64) with one or more gas separators (61). In one embodiment, one or more gas separators recover the gas recoverable product(s) (62) from the gas phase wherein the balance comprises gas dross (64) and is disposed of. In another embodiment, one or more gas separators recover the gas recoverable product(s) (62) from the gas phase, wherein the balance is recycled back (63) and/or sent to one or more subsequent wellbore reactors for further processing. In another embodiment, one or more gas separators recover gas components suitable for hydrogen donation, and recycle them back to any series of feedstock preparation and pre-feed operations.

### Solids Extraction & Separation

If one or more solids phase enters the wellbore reactor, and/or is formed within, it needs to be extracted to the surface. In one embodiment, one or more solids phases have sufficient buoyancy, dispersion and/or suspension properties, that they are, at least in part, extracted from the wellbore reactor via the upwardly flowing channel. In another embodiment, one or more solids phases, at least in part, settle out of solution, wherein they are, at least in part captured in one or more dropout chambers. In another embodiment, the one or more solids phases are removed from the dropout chamber, at least periodically. In another embodiment, siphon pipes are utilized to extract the solids to the surface.

### Gas Phase Recoverable Products

Some embodiments produce a gas phase, with one or more components or mixtures thereof (60) comprising recoverable products. In one embodiment, one or more gas separators (61) remove one or more dross gas components (64), such as water vapor, CO, CO₂ and/or other undesirable gases.

In one embodiment, one or more gas phase recoverable products, or mixtures thereof comprise combustible hydrocarbon gases such as methane, propane, ethane. In one embodiment one or more gas separators (61) separate one or more combustible hydrocarbon gases from the gas phase and comprise the gas product (62). In another embodiment, the combustible gases are further separated or otherwise purified with one or more subsequent gas phase separators to create one or more purified gas products. In another embodiment, one or more combustible gas product(s) are used for onsite electricity generation, combusted in the external heater, and/or recycled back to any series of feedstock preparation and pre-feed operations via the gas recycle.

In another embodiment, one or more gas phase recoverable products, or mixtures thereof comprises hydrogen gas. In one embodiment, one or more gas separators separate and purify Hydrogen from the gas phase and comprise the gas product. In another embodiment the hydrogen gas is recycled back to any series of feedstock preparation and pre-feed operations via the gas recycle. In another embodiment, the hydrogen gas is used for onsite electricity generation via combustion or as a fuel cell, or is combusted in the external heater.

In another embodiment, one or more gas phase recoverable products, or mixtures thereof (60) comprise the vapor fraction of liquid compounds, solvents, organic compounds, or any other component with a vapor fraction. In one embodiment one or more gas separators separate one or more vapor fractions of liquid compounds from the gas phase and comprise the gas product (62). In another embodiment, vapor fractions of liquid compounds are further separated or otherwise purified with one or more gas phase separators comprise one or more purified gas products. In another embodiment, one or more vapor fractions of liquid compounds, and are subsequently condensed back into a liquid state and comprise a recoverable product, recycled back to any series of feedstock preparation and pre-feed operations, used for onsite electricity generation, and/or combusted in the external heater.

### Liquid Phase Recoverable Products

Some embodiments produce one or more liquid phases or mixtures thereof (55) comprising recoverable products diluent(s), activator(s), and/or liquid dross(s). In one embodiment, one or more liquid separators (56) remove one or more liquid dross (59), comprising at least one of excess diluent, harmful liquid components, or other undesirable liquids. In another embodiment, activator(s) are removed with one or more liquid separators and are recycled back to any series of feedstock preparation and pre-feed operations via the fluids recycle (58).

In one embodiment one or more liquid separators separate one or more liquid hydrocarbon products, comprising crude oil substitutes and are the liquid recovered product (57). In another embodiment, crude oil substitutes are blended with crude oil, wherein it is co-processed into final fuels, comprising less than 90 wt% of the input, or < 75 wt%, <50 wt%, or < 25 wt%, or between 0.1-20 wt%, or between 0.2-15 wt%, or 0.3-10 wt% or 0.4-7.5 wt% or 0.5-5 wt%. In another embodiment, blending with crude oil is performed at the inputs or other early stages of the hydrocarbon processing facility.

In one embodiment one or more liquid separators separate one or more liquid hydrocarbon products, comprising one or more components of petroleum products from the liquid phases and comprise the liquid product. In another embodiment, the liquid product comprising components of petroleum products are further separated and/or purified into more than one liquid product, each comprising components of similar molecular weights, chemical properties and/or functional uses. In another embodiment, at least one of the components of petroleum products are representative of crude oil substitutes and are used in a manner similar thereof. In another embodiment, one or more components of petroleum products are inputted at one or more steps within the hydrocarbon processing facility, as a direct input or as a blend to one or more other inputs/feedstocks to supplement and/or aid the production of the desired petroleum product(s). In another embodiment, one or more components of petroleum products are inputted at one or more steps within an oil refinery facility, as a direct input or as a blend to one or more petroleum feeds to supplement and/or otherwise aid the production of final fuels.

In one embodiment one or more liquid separators separate one or more liquid hydrocarbon products, comprising components comprising one or more substitutes for final fuels, from the liquid phases and comprise the liquid product. In another embodiment, the liquid product comprising substitutes for final fuels are further separated and/or purified into more than one liquid products, each comprising components suitable for use as their representative final fuel. In one embodiment, the substitutes for final fuels are used as the pure, direct, or otherwise majority component in the fuel. In another embodiment, the substitute for final fuels are blended with petroleum counterparts to represent the final fuel.

In one embodiment, one or more liquid phases, or mixtures thereof, comprise combustible materials, and is combusted for onsite electricity generation and/or for the external heater. In another embodiment, one or more liquid phases, or mixtures thereof (55), comprise advanced materials, at least in part, in a dissolved, liquid and/or aqueous state.

In one embodiment one or more liquid separators separate soluble/aqueous organic compounds and are recovered as the liquid product (57). In another embodiment, one or more liquid separators break down the liquid entrained advanced materials into multiple outputs comprising heavy REE, medium REE, light REE, precious metals and/or critical metals. In another embodiment, elemental components of similar properties are separated and/or purified.

### Solid Phase Recoverable Products

Some embodiments may produce one or more solid components, precipitates, reaction agents, or mixtures thereof. In one embodiment, one or more solid components, comprise macro solids and/or bulk solids. In another embodiment, one or more solid components, comprise a suspension, colloidal suspension, or other liquid mediums that contain dispersed solid particles therein. In another embodiment, one or more solid components, are dispersed/suspended in the gas phase.

In one embodiment, one or more solids separators (52) on the surface, common in the art, including but not limited to: centrifuges, filters, membranes, sieves, cyclones, hydro cyclones, settlers, settling ponds, are used to separate different components from the solids phase (51). In another embodiment, one or more solids separators remove the reaction agent, wherein it is recycled back to any series of feedstock preparation and pre-feed operations via the reaction agent recycle (53). In another embodiment, one or more solids separators separate out the dross comprising harmful insoluble compounds, and/or other undesirable compounds.

In one embodiment, the precipitate contains, captures, encapsulates, or otherwise comprises insoluble components. In one embodiment, the precipitate comprises nitrogen, phosphorous, potassium, and/or other components suitable for fertilizers. In another embodiment, the precipitate comprises advanced materials. In another embodiment, one or more solids separators recover solid products comprising advanced materials from the solid phase. In another embodiment, one or more solids separators (52) segregate the advanced materials from the solids phase (51) into multiple outputs comprising heavy REE, medium REE, light REE, critical metals, precious metals and/or advanced carbon.

### EXAMPLES

The thermofluidic dynamics for 5 example configurations of the Universal Wellbore Reactor System facilitating different transformations of different feedstocks to different products were simulated.

| EX | Heat Exchange Configuration | Electro insulator | Energizable inner Component | | | Energizable Outer Component | | | Inner Pipe ID/OD | Middle Pipe ID/OD | Cuter Pipe ID/OD | Dropout. Chamber | Protection Annabus | Protection String |
|---|---|---|---|---|---|---|---|---|---|---|---|---|---|---|
| | | | Energized Component | Nonmagnetic | FerroMagnetic | Energized Component | Non- magnetic | FerroMagnetic | | | | | | |
| 1 | 1 HX chamber Cement | None | Inner Pipe | GOOD ft | 1500 ft | Middle Pipe | 6000 ft | 1500 ft | 3.5/4″ | 5/5.5″ | 6.5/7.5″ | 100 ft | Rockwood | Steel 10/11″ Cement 11/14″ |
| 2 | 2 HX Chambers HEz Cooper SFHZ: ALZOB Aerogel | Soild Alumina Inner & Middle pipe | Inner Piper | GOOD ft | 1500 ft | Middle Pipe | 7500 ft | 0 ft | 3.5/4″ | 5/5.5″ | 6.5/7.5″ | 300 ft. | Rockwood | Steel 10/11″ Cement 11/14″ |
| 3 | 2 HX Chonicers HEZ of. 1 m/sRow SFHZ: AtzobAerogel | Pass through | Inner Pipe | 3000 ft | 1500 ft | Outer Pipe | 4500 ft | 0 ft | 6.5/7″ | 8/5″ | 11.5/12.5″ | 100 ft | Rockwood | Steel 15.5/15.5″ Cement 16.5/20″ |
| 4 | Direct HX | PEEK Outer Pipe | InnerPipe | 4500 ft. | 2500 ft | Outer Pipe | 6000 ft. | 0 ft | 4/4.5″ | N/A | 6.5/7.5″ | 100 ft | Rockwood | Steel 10/11″ Cement 11/14″ |
| 5 | Direct HX | PEEK Central Conductor(HEZ) Alumina Central Conductor (SFHZ) | 0.5’ Rod. Central Conductor | 6000 ft | 1500 ft | inner Pipe | 6000 ft | 1500 ft | 4/4.5″ | N/A | 6.5/7.5″ | 300 ft | Rockwood | Steel 10/11″ Cement 11/34″ |

| Ex | Feedstock | Orient | Transform | Meater Output | Reactor input | End of HEZ Down | Era of SFMZ Down | 1.0% to surface | 25% to surface | 50% to surface | 75% to surface | Reactor Output | Reactor ResidenceTime | Recoverable Product |
|---|---|---|---|---|---|---|---|---|---|---|---|---|---|---|
| 1 | reactor Wastewater 1000 mg/min | water from feed 39 v/r.% | mt | 13 iuw | Inner Channel 90C 15 MPa | 193 C 31.6 MPa | 275 C 35 MPa | 315 C. 32.7 MPa | 344 C 28.0 MPa | 316 C 21.9 MPa | 286.2 C 15 MPa | Outer Channel 25.5 C. 8 MPa | 22.6 min | Liquid Hydrocarbon |
| 2 | Manures • Heavy Hydrocarbon 1000 kg/min | Water in feed 50 wt% | SCOT | 10 MW | Inner Channel 90 C 16.5 MPa | 289.6 C 34.3 | 330 C 36.6 MPa | 368 C 34.5 MPa: | 377 C 30.6 MPa | 335.2 C 24 MPa | 280 C 17.1 MPa | Outer Channel 21.5 c 10 MPa | 20.6 min | liquid Hydrocarbon |
| 3 | Min tostings 3000 kg/min | Water 95 wt.x | HIT | S.S MW | Outer Channel 125 C 14 MPa | 277 C 22.2 MPa | 357 C 25.3 MPa | 337 C 24.5 MPa: | 7.3 MPa | 309 C 20.0 MPa | 263 C 18 MPa | inner Channel 207.5 C 1.5 MPa | 45.5 mba | Anv. Materials |
| 4 | Forest Residues 3000 kg/min | Water, 70 kg% | HTT | 3 MW | inner Channel 30 C 17 MPa | 283 C 23.7 MPa | 35.5 C 32.4 MPa | 352 C 31 MPa | 306 C 28.7 MPa | 244 C 24.5 MPa | 378 C 19.8 MPa | Outer Channel 112 C 15 MPa | 24.3 min | liquid Hydrocarbon |
| 5 | 25 wt% Diy Ash + Hytdrocarbon waste 1000 g/min | water 80 kg% | SCDT | SMW | toner Channel 100 C 15 MPa | 387 C 28 MPa | 405 C 28 MPa | 401 C 28 MPa | 26.6 MPa | 379.5 c 24 MPa | 322.5 C 20.2 MPa | Outer Channel 244 C 15 MPa | 22.9 min | Adv.Material Adv. Carbon. H2 & Liquid Hydrocarbon |

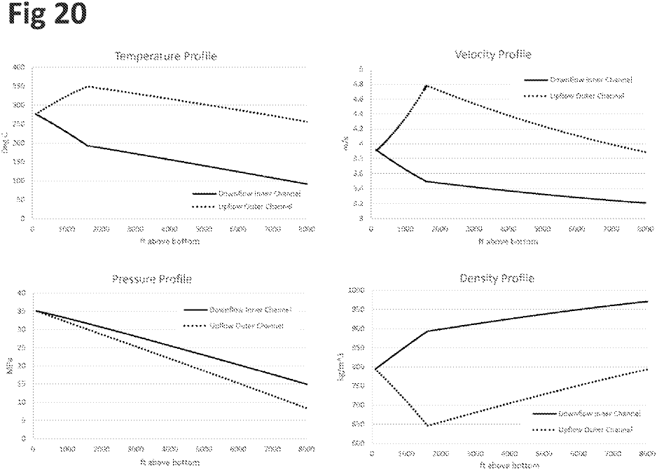

FIG. 20 shows the thermo-fluidic profiles from the simulation of example 1, wherein a wellbore reactor with heat exchange annulus is configured with a single heat exchange chamber, comprising no passthrough or sealing centralizers and a non-electroconductive heat transfer media, cement; and comprises continuous steel ferromagnetic components on the inner and middle pipe for the entire SFHZ. This configuration facilitates the HTT of a feedstock comprising the treated wastewater sludge, with a water diluent from the feedstock, comprising 90 wt% of the feed mixture, into a renewable hydrocarbon product comprising a substitute for crude oil, and/or components of petroleum products.

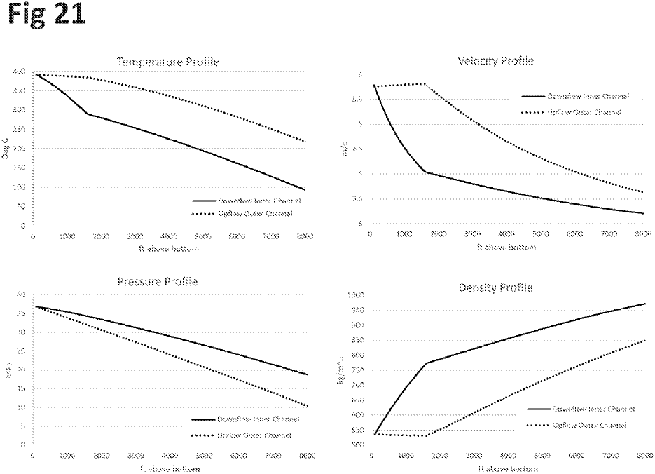

FIG. 21 shows the thermo-fluidic profiles from the simulation of example 2, wherein a wellbore reactor with heat exchange annulus is configured with 2 heat exchange chambers, comprising a sealing centralizer at the transition from the SFHZ and HEZ; and comprises continuous steel ferromagnetic components on the inner pipe for the entire SFHZ and ⅛″ thick aluminum cladding on the inside of the ferromagnetic middle pipe (410) for the total reactor length.

The heat exchange chamber within the SFHZ comprises non-electroconductive alumina aerogel, wherein the majority of skin effect heat transfer is directed to the downflowing inner channel, and the upflowing outer channel maintains the temperature within a few degrees. The heat exchange chamber within the HEZ comprises copper to increase the magnitude of internal heat transfer, and 1/16″ sintered alumina on the outer surface of the inner pipe and inner surface of the middle pipe to eliminate electrical conduction.

This configuration facilitates the SCDT of a feedstock comprising animal manures and 25% heavy hydrocarbons comprising bitumen, with respect to the dry hydrocarbon waste (i.e. on a dry basis), with a water diluent from the feedstock, comprising 60 wt% of the feed mixture, to a renewable hydrocarbon product comprising a substitute for crude oil, substitute for final fuels and/or components of petroleum products. Additionally, the reactor output comprises light hydrocarbon gasses and are recycled back to the wellbore reactor as an activator that serves as a hydrogen donor, which improves the quality of the recoverable product.

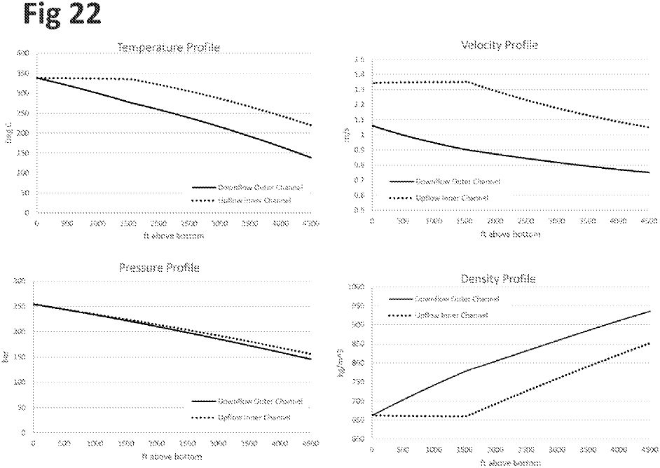

FIG. 22 shows the thermo-fluidic profiles from the simulation of example 3, wherein a wellbore reactor with heat exchange annulus is configured with 2 heat exchange chambers, comprising a sealing centralizer at the transition from the SFHZ and HEZ; and comprises continuous steel ferromagnetic components on the middle pipe for the entire SFHZ and ⅛″ thick aluminum cladding on the outside surface of the ferromagnetic inner pipe for the total reactor length.

The heat exchange chamber within the SFHZ comprises non-electroconductive alumina aerogel, wherein the majority of skin effect heat transfer is directed to the downflowing outer channel, and the upflowing inner channel maintains the temperature within a few degrees. The heat exchange chamber within the HEZ comprises pass through centralizers to prevent contact between the inner and middle pipe and a non-electroconductive fluidic heat transfer media, oil is discharged from heat transfer media tubing, at the lower regions of the HEZ heat exchange chamber. A fluid transfer device on the surface facilitates an upward heat transfer flow averaging 1 m/s, wherein the heated oil is recovered and utilized in an external heat exchanger to further increase the reactor input temperature.

This high magnitude of internal heat transfer enables the depth of the HEZ to be reduced, and the increased diameter extends residence time, particularly in the SFHZ. This configuration facilitates the HTT of a feedstock comprising metallic entrained industrial waste, such as mine tailings, with a 95 wt% water diluent, and is transformed into a recoverable product comprising advanced materials that is in a medium suitable for separation and/or purification processes known in the art.

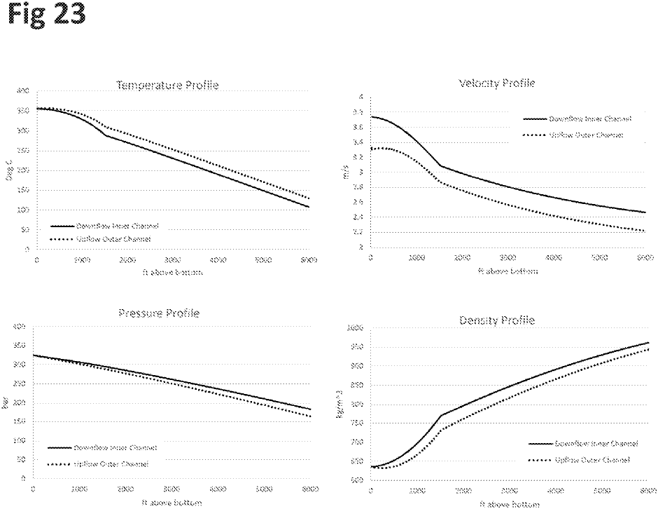

FIG. 23 shows the thermo-fluidic profiles from the simulation of example 4, wherein a wellbore reactor with direct heat exchange is configured with continuous ferromagnetic components on the inner pipe in the SFHZ, a passthrough circuit connector in the outer channel, and continuous nonmagnetic components, comprising ⅛″ PEEK electro-insulator on the inner surface of the outer pipe, for the total reactor length.

This configuration increases the magnitude of internal heat transfer and retains system efficiency with reduced HEZ depths.

This configuration facilitates the HTT of a feedstock comprising forest residues, and 70 wt% water diluent, into a renewable hydrocarbon product comprising a substitute for crude oil, substitutes for final fuels and/or components of petroleum products. Additionally, the liquid phase comprises hydrocarbon intermediaries and solvents, which are recycled back as an activator to improve reaction yields.

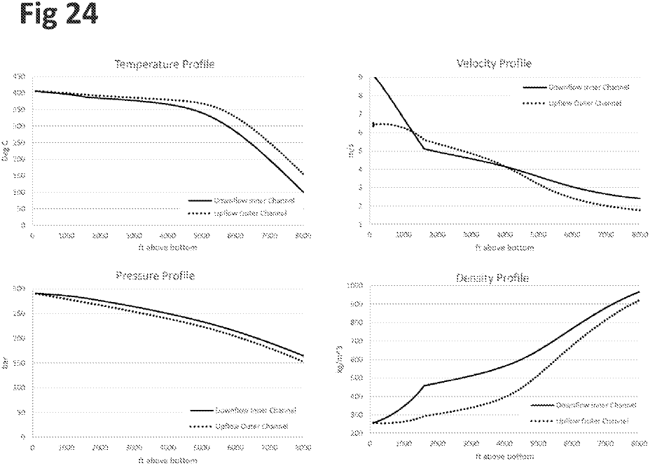

FIG. 24 shows the thermo-fluidic profiles from the simulation of example 5, wherein a wellbore reactor with direct heat exchange is configured with continuous ferromagnetic components on the inner pipe in the SFHZ, and a passthrough circuit connector in the inner channel.

A 0.5″ diameter central conductor comprises a continuous steel rod in the SFHZ, comprising 1 mm sintered aluminum oxide electro-insulator on the outer surface, and comprises a continuous aluminum rod in the HEZ, comprising ⅛″ PEEK electro-insulator on the outer surface. This configuration increases the magnitude of internal heat transfer, wherein most of the temperature is gained from the HEZ and the skin frequency heat transfer is concentrated to the downflowing inner channel, resulting in the lower half of the reactor holding the upper range of temperatures and pressures.

This configuration facilitates the SCDT of a feedstock comprising hydrocarbon waste and 25% fly ash with respect to the dry hydrocarbon waste, with 80 wt% water diluent, to recoverable products comprising renewable hydrocarbon products comprising crude oil substitutes, combustible hydrocarbon gasses, hydrogen gas, advanced carbon and a precipitate comprising advanced materials that is in a medium suitable for separation and/or purification processes known in the art. The combustible hydrocarbon gasses are used in an onsite electricity generator to supplement a portion of the frequency generator’s power consumption, and the coolant thereof is used to further preheat the feed mixture.

Example 6 comprises any configuration of wellbore reactors from Examples 1-5, wherein pipe modifications, representing turbulators are placed on the inner piping in the HEZ, to increase the magnitude of internal heat transfer, to increase the maximum temperature in the SFHZ and decrease the temperature of the reactor output.

Example 7 comprises any configuration of wellbore reactors from Example 6, wherein at least one deficiency in the targeted reaction(s) exists within the upflowing HEZ output. Reaction agents comprising functional metals are added to the reactor piping and/or piping modifications thereof in the locations representative of the deficient reaction mechanism(s) to increase the overall quality, function and/or performance of the recoverable products.

Example 8 comprises any configuration of wellbore reactors with heat exchange annulus from Examples 1-3, that comprise at least one deficiency in one or more targeted reaction(s) within the downflowing HEZ input, wherein a spool assembly at surface adjusts the location of variable activator tubing between a depth of 1000-2000 ft. Reactor sensors, located throughout the heat exchange annulus, measure temperature, pressure and velocity, and deliver readings back to surface via sensor connectors, which facilitate logic control circuitry and software known in the art, that controls the location of the of variable activator tubing discharge, along with the type and quantity of activators and/or reaction agents, to increase the overall transformation yield to recoverable products.

Example 9 comprises any configuration of wellbore reactors from Examples 1-5, that comprise at least one deficiency in one or more transformation reaction(s) within the SFHZ, wherein reaction baskets with comprise the entire SFHZ of the upflowing reactor output, to improve the overall transformation yield and/or the overall quality, function and/or performance of the recoverable products.

Example 10 comprises any configuration of wellbore reactors from Example 5 wherein a downhole pressure control device, that decreases pressure, is located in the upflowing outer channel output, 1500 ft below the surface, such that the subsequent decrease in pressure induces the precipitation of solids comprising advanced materials, and one or more dropout fishbone laterals, subsequently located above, capture the precipitates, wherein one or more siphon pipes, located in the fishbone drop out chamber, extract the precipitate to the surface, and is separated as the recoverable product.

Example 11 comprises a feedstock, which requires numerous steps to achieve product completion. The Universal Wellbore Reactor System includes three wellbores in series, each with different configurations.

The first wellbore reactor with direct heat exchange facilitates HTT and comprises a vertical depth of 5000 ft, wherein the SFHZ comprises the lower 1500 ft, and the HEZ makes up the balance. The waste mixture feedstock flows through two external heat exchangers, wherein first heat exchanger transfers heat to the feedstock from the output of the first wellbore reactor and the second heat exchanger transfers additional heat to the feedstock from the fluidic heat transfer media output of the second wellbore reactor, wherein the feedstock then enters the first wellbore reactor via the inner channel.

Piping modifications are on both surfaces of the inner piping 1000-2000 feet below the surface and increase the Reynolds number to assist dissolution of the downflowing feedstock, and to increase the magnitude of internal heat transfer. Furthermore, piping modifications are on the outer piping from 0-600 feet increases the magnitude of external heat transfer to the protection annulus which comprises auxiliary heat exchange tubes to further cool the reactor output in the outer channel.

At 3500 ft below the surface, the inner pipe transitions from aluminum or copper cladding to steel, and skin frequency heat transfer commences. Due to the physio-chemical characteristics of this feedstock, a 500 ft long fixed reaction basket (632) comprising catalytic material is affixed at a lower depth in the downflowing inner channel (255) and a 250 ft tall variable reaction basket (634) comprising chemical buffering agents, wherein its depth is adjusted between 2000-5000 ft in the outer channel (FIG. 6). The combination of these chemical and physical effects induce precipitation, wherein the upflowing velocity carries the targeted precipitate to the surface.

The fluid flow proceeds via the upflowing outer channel, and once at the surface, dross and the gas phase of the reactor output is collected and separated into recoverable products. The balance of the reactor output comprises partially transformed intermediaries to additional recoverable products and is combined with the discharge from the siphon pipe and is directed to the reactor connector stream.

The second wellbore reactor with heat exchange annulus is configured for SCDT, is 8000 ft deep and comprises fishbone laterals. The heat exchange annulus comprises two heat exchange chambers formed by one sealing centralizer at a depth of 4000 ft. The upper heat exchange chamber comprises pass through centralizers, wherein non-electroconductive oil comprises a positive displacement velocity of 1 m/s, and the lower heat exchange chamber comprises non electroconductive insulation materials. The bottom 3000 ft of the inner pipe comprises 3000 ferromagnetic energized components, while the middle pipe exclusively comprises nonmagnetic energized components. One or more pressure control tubes are located in the inner channel at a depth wherein the diluent transitions to the supercritical phase, and the pressure relief control device removes a sufficient mass from the inner channel to keep the pressure below 500 bar, wherein the output is sent to the final wellbore reactor.

The feed mixture enters the second wellbore reactor in the inner channel (255), wherein peak temperature is reached at the bottom of the downflowing channel, and the insulative heat exchange chamber maintains peak temperature for the 4000 ft of upflow in the outer chamber. The SCDT conditions completes the transformation of the partially transformed intermediaries, and further capture valuable non soluble components in the precipitate. At 4000 ft below the surface, a series of downhole pressure control devices, representing choke orifices extend 1500 ft up, and assist in the gradual depressurization of the output. As the depressurization occurs, the constituent molecules separate into more useful forms, and precipitation is induced. Dropout Fishbone laterals are at specified lengths and angles chosen to facilitate the recovery of the precipitate, are subsequently located above the downhole pressure control devices. A siphon pipe, operating in a pulsation mode, is located in every fishbone lateral, and draws the individual precipitates to the surface. The precipitates from each depth represent a unique recoverable product, and the discharges from the siphon pipe are kept segregated.

The reactor output is sent to one or more separators, to separate, residual solid precipitate comprising recoverable products, liquid phase recoverable products, gas phase recoverable products, and hazardous dross. The hazardous dross combines with a different diluent and the output from the pressure control tubing and is sent to the final wellbore reactor.

The final wellbore reactor is configured for HTT and is 500 ft deep with a 10,000 ft long horizontal lateral at maximum vertical depth. The horizontal lateral, minimizes the hydrostatic pressure, facilitating high temperature and low-pressure transformation reactions, that neutralize the hazardous dross, wherein it can be safely disposed of using traditional, non-specialized means.

1. A reactor system comprising at least one wellbore reactor for transforming a feed mixture of at least one feedstock into at least one of a product stream or an intermediate product output wherein the system comprises:
A. a well bore reactor comprising:
a. downward extending wellbore through a subsurface formation through which the wellbore extends by a distance that defines an elongated wellbore volume;
b. an elongated outer pipe and an elongated inner pipe define a channel volume including an inner channel and an outer channel in a counterflow configuration adapted to direct the feed mixture down one channel and upward through the other channel wherein at least one of the inner pipe and outer pipe is configured for heat transfer to at least one of the inner channel and outer channel; wherein at least one of the inner channel and the outer channel includes a ferromagnetic material in the form of a ferromagnetic region that occupies at least portion of the inner pipe and the outer pipe and that optionally occupies the full length of one of the inner pipe and the outer pipe; and wherein the inner channel and the outer channel are adapted to at least in part effect changes in temperature of the feed mixture as it passes through the channels; and the depth to which the counterflow configuration extends in the borehole at least in part produces changes in pressure of the feed mixture as it passes through the channels;
c. an optional middle pipe that extends at least partially within the outer pipe and the outside of the inner pipe wherein the at least a portion of the inner pipe and at least a portion of the middle pipe define a heat transfer annulus between at least a portion of the inner pipe and the middle pipe;
d. an optional central rod that extends within the inner channel;
e. the outer pipe and the inner pipe extend at least partially into the wellbore volume to for a length that contributes to the regulation of at least one of the magnitude of internal heat transfer between the inner channel and the outer channel and the profile of the pressure along the inner channel and the outer channel;
f. a protection annulus defined in part by the outside of the outer piping retaining a heat transfer media therein and adapted to regulate external heat exchange across the outer pipe;
g. a circuit return fixed to a lower portion of the inner piping and adapted in part to provide a conductive path that includes least one ferro conductive region; and,
h. at least one non-electroconductive component fixed to at least a portion of at least one of the outer piping, the inner piping, the optional inner piping and the optional central conductor that inhibits the conduction of electrical energy between at least two ferromagnetic regions wherein at least a portion of the non-conductive component comprises at least one of: a non-electroconductive structure fixed with respect to at least one of the inner pipe, the outer pipe, the optional middle pipe and the optional central conductor; an electro insulator fixed to at least one wall of at least one of the inner pipe, the outer pipe, the optional middle pipe and the optional central conductor and a non-electroconductive heat transfer media confined in part by at least one of outer wall of the inner elongated conduit or the optional middle wall;
i. an electrical input point located to deliver electrical energy to at least one of the inner pipe, the outer pipe, the optional middle pipe; and the optional conductor; and,
j. an electrical output point located to recover electrical energy from at least one of the inner pipe, the outer pipe, the optional middle pipe; and the optional conductor; and,
B. a frequency generator adapted to provide electrical energy to at least one ferromagnetic region and adapted produce a temperature of 20 to 760° C. in at least one of the inner channel and the outer channel;
C. and input conduit in communication with one of the inner channel and the outer channel of the wellbore reactor to deliver a feed mixture from at least one wellbore reactor; and,
D. an output conduit in communication with one of the inner channel and the outer channel to recover at least one of the _output stream and the intermediate product output from at least one well bore reactor.

2. The system of claim 1 wherein the system includes at least one of:
a. multiple wellbore reactors;
b. a wellbore reactor wherein the well bore defines at least one of a principally horizontal section; a lateral section and a fishbone section;
c. a well bore that varies along its length in at least one of diameter or cross-sectional configuration; and,
d. at least one pressure control structure affixed to at least one of reactor piping, the optional middle pipe and the optional central conductor.

3. The system of claim 1 wherein at least one tube for the addition or withdrawal of at least one of a fluid and a fluid transported solid wherein the tube extends above the subsurface formation for communication of the fluid to or from a destination located above subsurface formation and to or from at least one of the inner annulus, the outer annulus, the heat exchange annulus and the protection annulus.

4. The system of claim 1 wherein at least one reaction basket is located within at least one of the inlet channel, the outlet channel or the heat exchange channel.

5. The system of claim 1 wherein the system comprises at least one of a circuit return comprising a structure that permits fluid flow through it and a circuit return having a structure that blocks fluid flow through it.

6. The system of claim 1 wherein the surface of at least one of the reactor piping; the middle pipe and the central conduit retain at least one structure for the modification of fluid flow on at least one of their outside surfaces wherein the structure is selected from the group comprising ribbing, baffles, turbulators, fins, pipe couplers, planned piping corrosion and combinations thereof and the structure for modification of fluid flow is adapted to provide at least one of enhanced agitation of flowing fluid; additional internal heat transfer between the inner channel and the outer channel; the regulation of skin frequency heat transfer and improved conversion of the feed mixture as it contacts a reactive surface cladding.

7. The system from of claim 1 wherein the protection annulus is adapted to further comprise at least one of:
a. adapting the protection annulus media to cause one of reducing heat transfer from the protection annulus into the subsurface structure across the outer pipe and increasing heat transfer from the subsurface structure into the outer channel across the outer pipe;
d. retaining a fluidic heat transfer media as the protection annulus media wherein the fluidic heat transfer media is adapted to decrease the temperature of the outer channel; the system further comprises an external heat exchanger; the fluidic heat transfer media is recovered from the wellbore and transferred to the external heat exchanger; heat transfer piping communicates the fluidic heat transfer media with the heat exchanger; and the heat transfer piping and heat exchanger are adapted to exchange heat between the fluidic heat transfer media and a least a portion of the feed mixture to adjust the temperature of the reactor input; and,
e. reactor sensors located within the protection annulus.

8. The system of claim 1 wherein the wellbore reactor comprises at least one dropout chamber located below the distal end of one of the inner pipe and the outer pipe, and the well bore; the dropout chamber is defined at least in part by at least one of the inside of the outer pipe and the wellbore; the distal end of on the wellbore; or a portion of a wellbore lateral, wherein the dropout chamber is adapted to capture precipitate that comprises at least one of dross, the product and recoverable product precursors and wherein the dropout chamber optionally has at least one siphon pipe in communication with the dropout chamber to withdraw precipitate from the dropout chamber.

9. The system of claim 1 further comprising a first wellbore reactor and at least one additional wellbore reactor adapted to:
a. produce at least one additional recoverable product;
b. increase the cumulative wellbore reactor volume of the system;
c. perform transformation reactions with two wellbore reactors in the system that are adapted to operate with at least one of different pressures, different temperatures, different reaction mechanisms, and different reactor dynamics; and,
d. produce dross in the first wellbore reactor and process at least a portion of a dross produced by the first wellbore reactor in the additional wellbore reactor and the additional wellbore reactor is adapted to do at least one of the following with dross recovered from the additional well bore reactor: prepare the dross for recycle to at least one of the first wellbore rector and the additional wellbore is adapted to prepare the dross for safe disposal; transformation of the dross into a recoverable product, and recycle of the dross.

10. The system of claim 1 further comprising at least one of an external heat exchanger adapted to transfer heat between at least one feed mixture and at least one product stream; and at least one external heater adapted to provide a feed mixture input temperature of 75-300° C.

11. The system of claim 1 wherein the wellbore reactor is adapted for transformation of the feed mixture at a temperature of 30 to 90° C. and a pressure of 1-200 bar wherein the feed mixture comprises at least one of animal manures, municipal waste from wastewater treatment plants, food processing waste, and hydrocarbon waste by the wellbore reactor is further adapted to transform the feed mixture by at least one of thermophilic digestion, mesophilic digestion and biotic processes, wherein the transformation uses a diluent primarily comprises water and transforms the feed mixture to a recoverable products comprising at least one of combustible hydrocarbon gases and hydrogen gas.

12. The system of claim 1 wherein at least one wellbore reactor is configured for hyperthermal transformation at a temperature of 250-372° C. and a pressure of 75-500 bar, to transform hydrocarbon waste to one or more recoverable products comprising at least one of renewable hydrocarbon products and hydrogen gas.

13. The system of claim 5, wherein the system comprises a heat exchange annulus bound by the outer wall of the inner pipe, and inner wall of the middle pipe; the use of the circuit return having a structure that blocks fluid flow and at least spans the gap between the inner and middle pipe; a position that defines the bottom of the heat exchange annulus; at least one heat exchange chamber that retains an annulus heat exchange media and that comprises a portion of the heat exchange annulus wherein the heat exchange annulus is defined in part by at least one of a pass through centralizer and a sealing centralizer and adapted to regulate the internal heat exchange between the inner channel and outer channel by:
a. increasing the internal heat transfer;
b. decreasing the internal heat transfer;
c. decreasing the temperature of the reactor output;
d. increasing the maximum temperature within the reactor; and
f. maintaining independent temperatures profiles for the inner channel and outer channel.

14. The system of claim 14 wherein the system further comprises:
a. at least one tube that extends into the heat exchange annulus and communicates the annulus heat exchange media with, at least one of the inner channel and the outer channel and heat exchange media within one or more heat exchange chambers;
b. two or more heat exchange chambers with each comprising a different heat transfer media; and,
c. reactor sensors and connections for reactor sensors located in the heat exchange annulus.

15. The system of claim 1 wherein the well bore extends downward at least 1000 ft. and is adapted for super critical diluent transformation, at a temperature of 373-600° C. and a pressure of 220-600 bar to transform hydrocarbon waste that in part comprises water and the water at least in part serves as a diluent and wherein the transforming of hydrocarbon is adapted to produce to one or more recoverable products comprising at least one of renewable hydrocarbon products and hydrogen gas.

16. The wellbore reactor system of claim 1 wherein the system is adapted to receive a feedstock comprises heavy hydrocarbons that comprise 1-75 wt.% of a feedstock on dry basis.

17. The system of claim 1, wherein the wellbore reactor is configured for Hyperthermal Transformation or Supercritical Diluent Transformation and adapted for the transformation of at least one of a metallic entrained waste and a mineral rich resource to a recoverable product comprising at least one of advanced materials and suitable precursors thereof wherein the well bore is adapted for transformation at a temperature of 175-600° C. and a pressure of 50-600 bar.

18. The wellbore reactor system of claim 1 wherein the wellbore reactor is adapted for at least one of Hyperthermal Transformation and Supercritical Diluent Transformation and is further adapted to provide a temperature of 250-600° C. and a pressure of 50-600 bar for the transformation feed mixture to renewable hydrocarbon products comprising at least one of crude oil substitutes, substitutes for final fuels, components of petroleum products combustible hydrocarbon gas, and hydrogen gas.

19. The system of claim 1 wherein the wellbore reactor is adapted to batch,
semi- batch or continuous operations to and adapted do at least one of the following transformation reactions:
a. near ambient transformation at a temperature of 30-90° C. and a pressure of 1-200 bar;
b. hyperthermal transformation, wherein the wellbore reactor includes a diluent pipe to introduce a diluent into at least one of the inner channel or outer channel and the wellbore reactor is adapted to maintain at least one of the temperature and pressure below the critical point of the diluent; and,
c. supercritical diluent transformation wherein the wellbore reactor includes a diluent pipe to introduce a diluent into at least one of the inner channel or outer channel and the wellbore reactor is adapted to provide a temperature and pressure above the critical point of the diluent.

20. The wellbore reactor system of 1, wherein the wellbore reactor is configured to enable the transformation of hydrocarbon waste to renewable hydrocarbon products.

21. A method of transforming at least one feedstock to one or more recoverable products with a wellbore reactor system, comprising one or more wellbore reactors extending at least 100 ft into a subterranean formation, operating in a batch, semi-batch or continuous mode, by the method comprising:
a) forming a feed mixture (26) comprising at least one feedstock, at least one diluent, optionally at least one organic activator, and optionally at least one reaction agent
b) raising the pressure of the feed mixture with an injection pump that provides a portion of the reactor pressure and passing the feed mixture into a counterflow channel configuration located in the wellbore reactor wherein at least one pipe separates an upflow channel from a downflow channel of the channel configuration and one of the upflow channel or the downflow channel extends through the other of the upflow channel and the downflow channel wherein feed mixture flows down to the lower regions of the reactor, and flows back up the opposite channel in the counterflow channel configuration;
c) increasing the temperature in the downflow channel at least in part by internal heat exchange with the upflow channel;
d) Increasing the pressure in the downflow channel at least in part by increasing hydrostatic pressure generated from increasing depth of fluid mixture in the feed mixture in the downflow channel;
e) heating at least one of the inner channel and the outer channel to final temperature by the skin frequency heating of a ferro-magnetic energized components which deliver skin frequency heat transfer to at least one of the inner channel and outer channel;
f) maintaining the inner channel and the outer channel at a temperature of from 20 to 600° C. and a pressure of from 1 to 600 bar; and,
g) recovering a reactor output from the wellbore reactor comprising the recoverable product.
